(19) United States
(12) Patent Application Publication
(10) Pub. No.: US 2012/0057216 A1
(43) Pub. Date: Mar. 8, 2012

(54) MULTICOMPONENT SACRIFICIAL STRUCTURE

(75) Inventors: Lucio Flores, San Jose, CA (US); Lior Kogut, Haifa (IL); Xiaoming Yan, Sunnyvale, CA (US); Thanh Tu, San Jose, CA (US); Qi Luo, Cupertino, CA (US); Brian J. Gally, Los Gatos, CA (US); Dana Chase, Cupertino, CA (US); Gang Xu, Cupertino, CA (US); Sheng-Tzung Huang, Taoyuan City (TW); Chia Wei Yang, Hsinchu (TW); Yi Fan Su, Sinfong Township (TW)

(73) Assignee: QUALCOMM MEMS TECHNOLOGIES, INC., San Diego, CA (US)

(21) Appl. No.: 12/680,550

(22) PCT Filed: Sep. 28, 2007
(86) PCT No.: PCT/US2007/020922

§ 371 Date: Oct. 24, 2011

(51) Int. Cl. G02B 26/00; C23F 1/02

(52) U.S. Cl. 359/290; 216/24

(57) ABSTRACT

A MEMS comprising a sacrificial structure, which comprises a faster etching portion and a slower etching portion, exhibits reduced damage to structural features when in forming a cavity in the MEMS by etching away the sacrificial structure. The differential etching rates mechanically decouple structural layers, thereby reducing stresses in the device during the etching process. Methods and systems are also provided.

### BACKGROUND OF THE INVENTION

1. Technical Field

This application is generally related to microelectromechanical systems (MEMS), and more particularly, to MEMS with cavities and methods for forming the same.

2. Description of the Related Art

Microelectromechanical systems (MEMS) include micro mechanical elements, actuators, and electronics. Micromechanical elements may be created using deposition, etching, and/or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY OF THE INVENTION

A MEMS comprising a sacrificial structure, which comprises a faster etching portion and a slower etching portion, exhibits reduced damage to structural features when in forming a cavity in the MEMS by etching away the sacrificial structure. The differential etching rates mechanically decouple structural layers, thereby reducing stresses in the device during the etching process. Methods and systems are also provided.

Accordingly, some embodiments provide an apparatus comprising a microelectromechanical systems device, wherein the micromechanical systems device comprises: a sacrificial structure formed over a first structural layer; and a second structural layer formed over the sacrificial structure. The second structural layer comprises a plurality of etchant access openings extending through the second structural layer, the sacrificial structure comprises a first portion proximal to the first structural layer and a second portion distal to the first structural layer, one of the first portion and the second portion is selectively etchable in the presence the other of the first portion and the second portion, and the sacrificial structure is selectively etchable in the presence of the first structural layer and the second structural layer.

In some embodiments, one of the first portion of the sacrificial structure and the second portion of the sacrificial structure is etchable by a preselected etchant at a faster rate than the other of the first portion and the second portion. In some embodiments, the second portion of the sacrificial structure is etchable by the preselected etchant at a faster rate than the first portion of the sacrificial structure.

In some embodiments, the sacrificial structure comprises a sacrificial layer having a graded composition between the first portion of the sacrificial structure and the second portion of the sacrificial structure.

In some embodiments, the first portion of the sacrificial structure comprises a first sacrificial layer and the second portion of the sacrificial structure comprises a second sacrificial layer. In some embodiments, the first sacrificial layer and the second sacrificial layer have different compressions. In some embodiments, the sacrificial structure further comprises a third sacrificial layer, wherein at least one of the first sacrificial layer and second sacrificial layer is etchable by a preselected etchant at a faster rate than the third sacrificial layer.

In some embodiments, the first portion of the sacrificial structure comprises a plurality of sacrificial layers forming interface regions therebetween, and the second portion comprises the interface regions. In some embodiments, the sacrificial layers comprise substantially the same material formed under substantially the same conditions.

In some embodiments, the sacrificial structure comprises at least one of W, Mo, Nb, Ta, Re, Cr, Ni, Al, Ga, In, Sn, Ti, Pb, Bi, Sb, B, Si, Ge, and combinations, alloys, or mixtures thereof. In some embodiments, the sacrificial structure comprises a photoresist.

In some embodiments, the preselected etchant comprises XeF₂. In some embodiments, an etching selectivity between the first portion of the sacrificial structure and the second portion of the sacrificial structure is at least about 2.5:1 using the preselected etchant.

In some embodiments, the sacrificial structure consists of two sacrificial layers.

In some embodiments, the first structural layer comprises a dielectric material. Some embodiments further comprise an electrode formed below the first structural layer. In some embodiments, the second structural layer comprises a deformable layer.

Some embodiments further comprise: a movable reflective layer formed between the sacrificial structure and the second structural layer; a connector coupling the second structural layer and the movable reflective layer; and a layer of a sacrificial material formed between the second structural layer and the movable reflective layer. Some embodiments further comprise a support structure extending between the first structural layer and the second structural layer.

In some embodiments, the microelectromechanical systems device is an interferometric modulator.

Some embodiments further comprise: a display; a processor that is configured to communicate with said display, said processor being configured to process image data; and a memory device that is configured to communicate with said processor.

Some embodiments further comprise a driver circuit configured to send at least one signal to the display. Some embodiments further comprise a controller configured to send at least a portion of the image data to the driver circuit. Some embodiments further comprise an image source module configured to send said image data to said processor. In some embodiments, the image source module comprises at least one of a receiver, transceiver, and transmitter. Some embodiments further comprise an input device configured to receive input data and to communicate said input data to said processor.

Some embodiments provide a method of fabricating a microelectromechanical systems device, the method comprising: forming over a first structural layer a sacrificial structure comprising a first portion proximal to the first structural layer and a second portion distal to the first structural layer, wherein the sacrificial structure is selectively etchable in the presence of the first structural layer and the second structural layer, and one of the first portion and the second portion is selectively etchable in the presence of the other of the first portion and the second portion; forming a second structural layer over the sacrificial structure; and forming a plurality of etchant access openings extending through the second structural layer.

In some embodiments, one of the first portion and the second portion is etchable by a preselected etchant at a faster rate than the other. Some embodiments further comprise etching away one of the first portion and second portion using the preselected etchant. In some embodiments, etching away one of the first and second portions using the preselected etchant comprises etching away one of the first and second portions using XeF₂.

In some embodiments, forming the sacrificial structure comprises forming a first sacrificial layer proximal to the first structural layer and a second sacrificial layer distal to the first structural layer. In some embodiments, forming the sacrificial structure comprises forming a sacrificial layer comprising a graded composition between the first portion and the second portion. In some embodiments, forming the sacrificial structure further comprises forming a third sacrificial layer, wherein a preselected etchant etches at least one of the first sacrificial layer and second sacrificial layer faster than the third sacrificial layer.

Some embodiments provide a method of manufacturing a microelectromechanical systems device comprising: forming a sacrificial layer over a first layer; forming a second layer over the sacrificial layer; selectively etching the sacrificial layer from between the first layer and the second layer to form at least one pillar extending between the first layer and the second layer; and mechanically decoupling the sacrificial layer from at least one of the first layer and the second layer before etching away the at least one pillar.

In some embodiments, forming the sacrificial layer comprises forming a layer comprising at least one of germanium and molybdenum oxide. In some embodiments, forming the second layer comprises forming an aluminum movable reflective layer. In some embodiments, mechanically decoupling the sacrificial layer comprises mechanically decoupling from the second layer.

Some embodiments provide an apparatus comprising a microelectromechanical systems device, wherein the micromechanical systems device comprises: a first sacrificial layer contacting a first structural layer; a second sacrificial layer formed over the first sacrificial layer; and a second structural layer contacting the second sacrificial layer. The first sacrificial layer and the second sacrificial layer are selectively etchable in the presence of the first structural layer and the second structural layer using a preselected etchant, and one of the first sacrificial layer and second sacrificial layer is etched by the preselected etchant at faster rate than the other.

Some embodiments further comprise a plurality of etchant access openings extending through the second structural layer.

Some embodiments provide an apparatus comprising a microelectromechanical systems device, wherein the micromechanical systems device comprises: a dielectric layer formed over a first conductive layer; a sacrificial structure formed over the dielectric layer; and a second conductive layer formed over the sacrificial structure, wherein the sacrificial structure is selectively etchable in the presence of the dielectric layer and the second conductive layer using a preselected etchant, and the sacrificial structure comprises a faster etching portion and a slower etching portion with respect to the preselected etchant.

In some embodiments, the sacrificial structure comprises a graded layer of the faster etching portion and the slower etching portion.

Some embodiments provide an apparatus comprising a microelectromechanical systems device, wherein the micromechanical systems device comprises: a compositionally non-uniform sacrificial structure formed over a first structural layer; and a second structural layer formed over the sacrificial structure, wherein the second structural layer comprises a plurality of etchant access openings extending through the second structural layer, the sacrificial structure is selectively etchable in the presence of the first structural layer and the second structural layer, and a preselected etchant etches the sacrificial structure non-uniformly.

Some embodiments provide an apparatus comprising a microelectromechanical systems device, wherein the micromechanical systems device comprises: a first structural means for supporting the microelectromechanical systems device; a sacrificial means for forming a cavity in the microelectromechanical systems device; and a second structural means for actuating the microelectromechanical systems device, wherein the second structural means comprises a plurality of etchant access means for contacting the sacrificial means with an etchant means, and the sacrificial means comprises a faster etching portion and a slower etching portion.

In some embodiments, the first structural means comprises a substrate. In some embodiments, the sacrificial means comprises a sacrificial structure. In some embodiments, the second structural means comprises a deformable layer.

Some embodiments provide a method of manufacturing a microelectromechanical systems device comprising: forming a sacrificial structure over a first layer; forming a second layer over the sacrificial structure; and selectively etching away the sacrificial structure substantially completely from between the first layer and the second layer using a preselected etchant, wherein the sacrificial structure comprises a faster etching portion and a slower etching portion with respect to the preselected etchant.

In some embodiments, forming a sacrificial structure comprises forming a plurality of sacrificial layers.

Some embodiments provide an apparatus comprising a microelectromechanical systems device, wherein the micromechanical systems device comprises: a sacrificial structure formed over a first structural layer; and a second structural layer formed over the sacrificial structure. The sacrificial structure comprises a first portion and a second portion, one of the first portion and the second portion has a faster intrinsic etching rate using a preselected etchant, the sacrificial structure is selectively etchable in the presence of the first structural layer and the second structural layer using the preselected etchant, and an aspect ratio of a width or length to thickness of the sacrificial structure is at least about 50:1.

In some embodiments, the aspect ratio of the width and length to thickness of the sacrificial structure is at least about 50:1. In some embodiments, the aspect ratio of the width or length to thickness of the sacrificial structure is at least about 100:1.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column signals that may be used to write the frame of FIG. 5A.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIGS. 8A-8E are cross sections of embodiments of unreleased interferometric modulators corresponding to the released interferometric modulators illustrated in FIGS. 7A-7E.

FIG. 9A is a cross section of an embodiment of an unreleased interferometric modulator comprising a multicomponent sacrificial structure. FIG. 9B is a top view of the unreleased interferometric modulator illustrated in FIG. 9A.

FIG. 9C is a cross section of an embodiment of an unreleased interferometric modulator in which the sacrificial structure comprises two sacrificial layers.

FIG. 9D is a cross section of an embodiment of an unreleased interferometric modulator in which the sacrificial structure comprises three sacrificial layers.

FIGS. 9E-9G are cross sections of an embodiment of the interferometric modulator illustrated in FIG. 9C at different stages of a release etch.

FIG. 9H is a cross section of an embodiment of an interferometric modulator comprising a graded sacrificial structure at an intermediate stage of a release etch.

FIGS. 9I-9K are cross sections of an embodiment of an interferometric modulator with a sacrificial structure comprising two similar sacrificial layers and intermediate stages in the etching thereof. FIG. 9L is a cross section of an intermediate stage of etching of a similar interferometric modulator with a single layer sacrificial structure.

FIG. 10 is a flowchart schematically illustrating an embodiment of a method for manufacturing a MEMS using a multicomponent sacrificial structure.

FIG. 11 a cross section of an embodiment of an interferometric modulator comprising a single component sacrificial structure at an intermediate stage of a release etch.

FIG. 12 is a cross section of an embodiment of an interferometric modulator comprising a two-layer sacrificial structure.

FIG. 13 is through-substrate view of an array of interferometric modulators manufactured using multicomponent sacrificial structures after a release etch.

FIG. 14 is a through-substrate view of an array of interferometric modulators manufactured using single component sacrificial structures at an intermediate stage of a release etch.

FIG. 15 is a through-substrate view of an array of interferometric modulators manufactured using single component sacrificial structures at an intermediate stage of a release etch.

FIG. 16 is a through-substrate view of an array of interferometric modulators manufactured using single component weakly-adhering sacrificial structure after release.

FIG. 17 is a through-substrate view of an array of interferometric modulators manufactured using two-component weakly-adhering sacrificial structure after release.

FIG. 18 is a through-substrate view of an array of interferometric modulators manufactured using another two-component weakly-adhering sacrificial structure after release.

FIG. 19 is an electron micrograph of the interface between the movable reflective layer and the two-component weakly-adhering sacrificial structure used in the manufacture of the array illustrated in FIG. 18.

FIGS. 20A-20C are release radius maps for interferometric modulator arrays comprising one-layer, two-layer, and three-layer sacrificial structures, respectively.

FIGS. 21A and 21B illustrate results of release radius measurements of interferometric modulator arrays comprising one-layer, two-layer, and three-layer sacrificial structures.

FIG. 22 illustrates relative etching rates for embodiments of single-component and multicomponent sacrificial structures.

FIGS. 23A-23F are cross-sectional scanning electron micrographs of partially etched interferometric modulator arrays comprising one-layer, two-layer, and three-layer sacrificial structures.

### DETAILED DESCRIPTION OF SOME PREFERRED EMBODIMENTS

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

In some embodiments for manufacturing interferometric modulators and other MEMS devices, one or more cavities are created in the MEMS by etching away one or more sacrificial layers disposed between relatively movable components of the completed MEMS, for example, the substrate and the deformable layer. In this etching step, damage to the MEMS can occur because etching away a sacrificial layer permits motion between the relatively movable components even before the etching is completed. As the sacrificial layer is etched, the remaining portions form islands and/or pillars extending between the relatively movable components. In particular, relative motion between the components causes stress at these islands or pillars. If the stress becomes large enough, one of the components will fail to relieve the stress. In some cases, the failure is to one or more components that are critical to the functioning of the MEMS. In some embodiments, damage may be prevented in the etching process by employing a sacrificial structure between the relatively movable components that mechanically decouples the relatively movable components before the sacrificial structure is completely etched away. In some embodiments, the sacrificial structure is a non-uniformly etchable sacrificial structure, for example, comprising at least differentially etchable first portions and second portions.

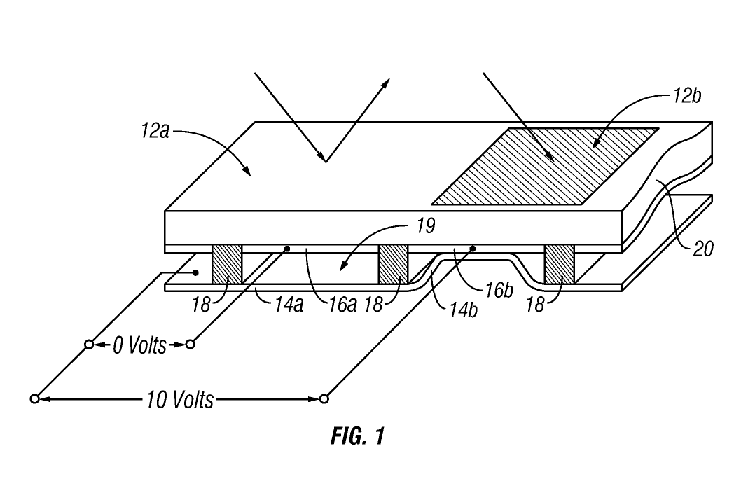

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent, and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in FIG. 1) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

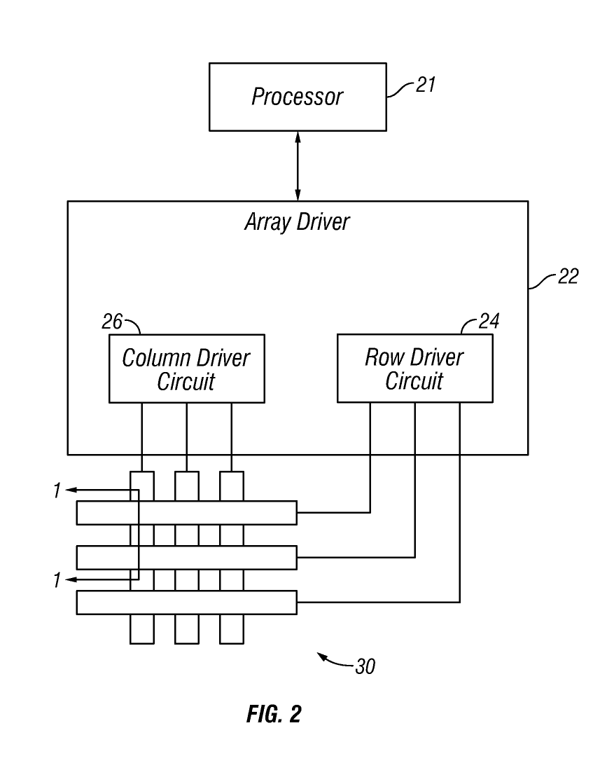

FIGS. 2 through 5B illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

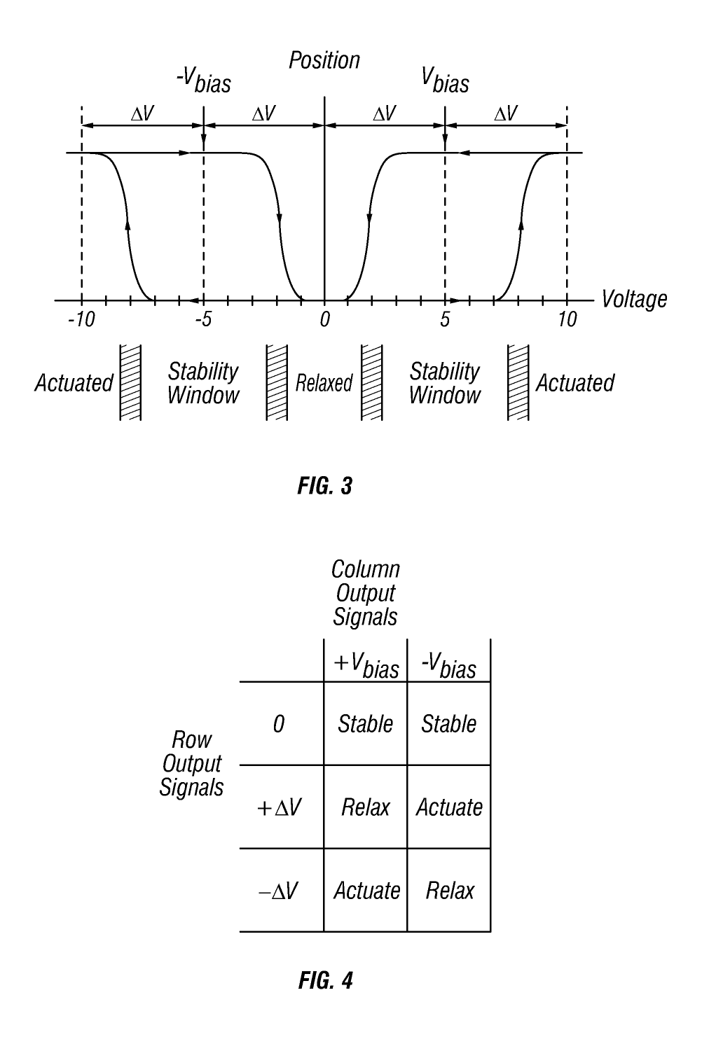

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. Thus, there exists a window of applied voltage, about 3 to 7 V in the example illustrated in FIG. 3, within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

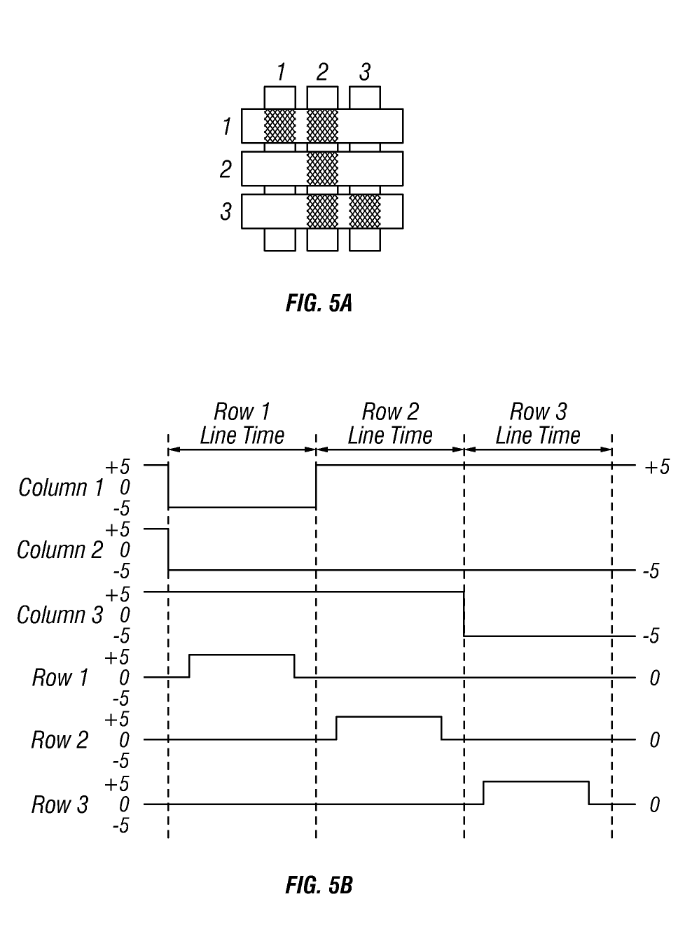

FIGS. 4, 5A, and 5B illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias} and the appropriate row to +ΔV, which may correspond to −5 volts and +5 volts, respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias} or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

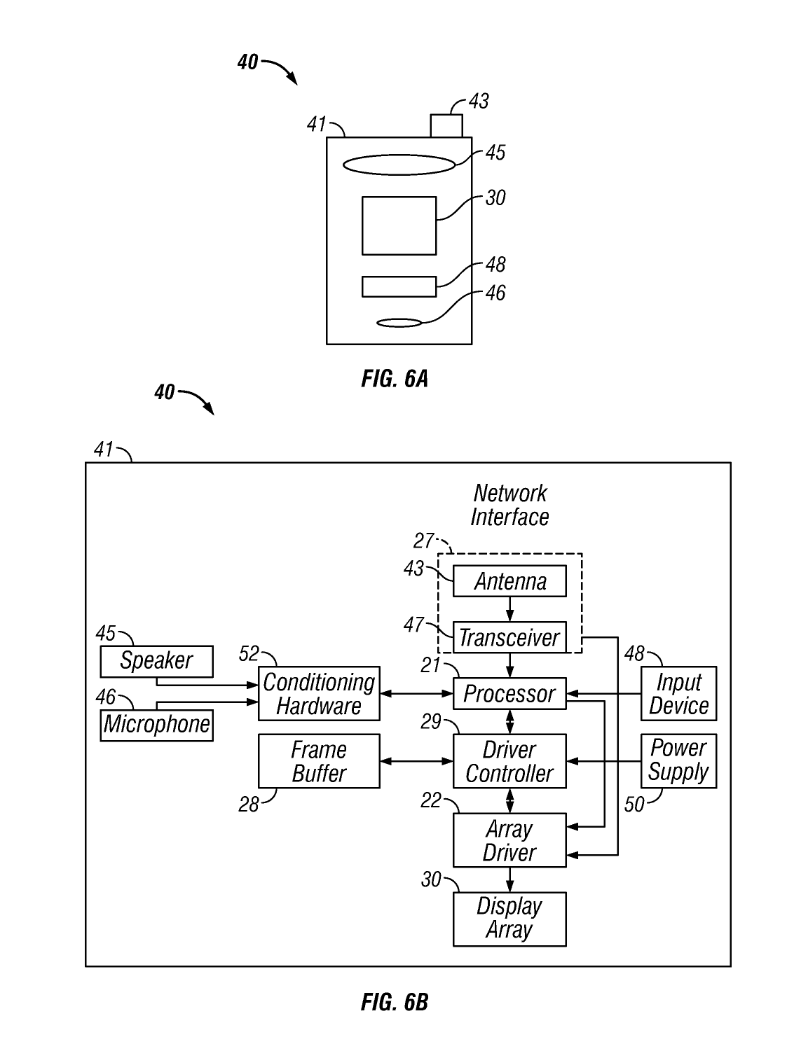

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes as are well known to those of skill in the art, including injection molding and vacuum forming. In addition, the housing 41 may be made from any of a variety of materials, including, but not limited to, plastic, metal, glass, rubber, and ceramic, or a combination thereof. In one embodiment, the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28 and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment, the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, the network interface 27 can be replaced by an image source, which can store or generate image data to be sent to the processor 21. For example, the image source can be a digital video disc (DVD) or a hard-disc drive that contains image data, or a software module that generates image data.

The processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, the driver controller 29 is a conventional display controller or a bi-stable display controller (e.g., an interferometric modulator controller). In another embodiment, the array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, the input device 48 includes a keypad, such as a QWERTY keyboard or a telephone keypad, a button, a switch, a touch-sensitive screen, or a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

The power supply 50 can include a variety of energy storage devices as are well known in the art. For example, in one embodiment, the power supply 50 is a rechargeable battery, such as a nickel-cadmium battery or a lithium ion battery. In another embodiment, the power supply 50 is a renewable energy source, a capacitor, or a solar cell including a plastic solar cell, and solar-cell paint. In another embodiment, the power supply 50 is configured to receive power from a wall outlet.

In some embodiments, control programmability resides, as described above, in a driver controller which can be located in several places in the electronic display system. In some embodiments, control programmability resides in the array driver 22. Those of skill in the art will recognize that the above-described optimizations may be implemented in any number of hardware and/or software components and in various configurations.

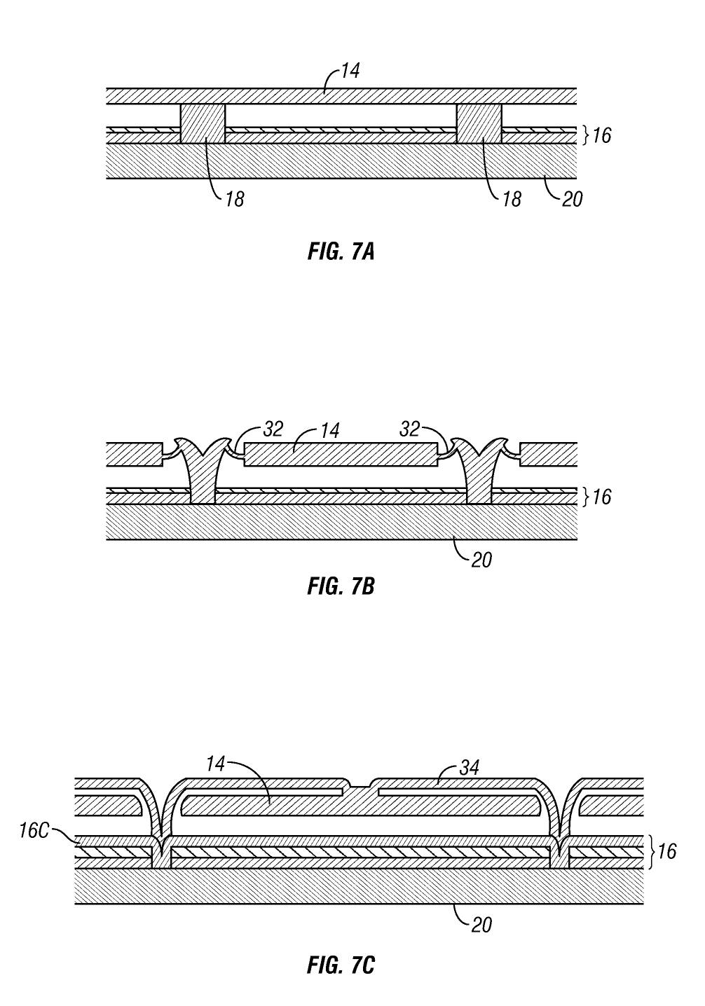

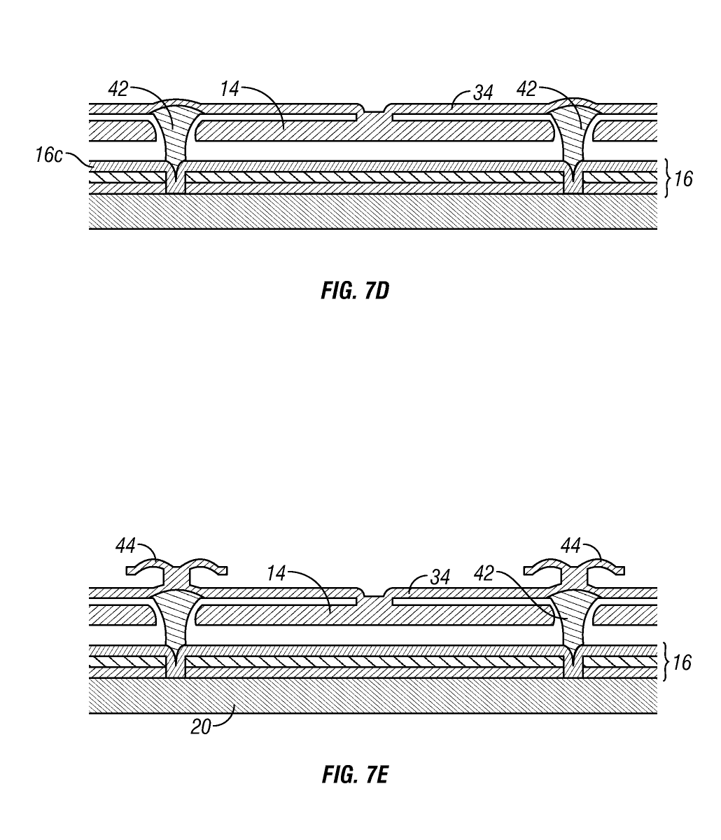

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 is attached to supports at the corners only, on tethers 32. In FIG. 7C, the moveable reflective layer 14 is suspended from a deformable layer 34, which may comprise a flexible metal. The deformable layer 34 connects, directly or indirectly, to the substrate 20 around the perimeter of the deformable layer 34. These connections can take the form of continuous walls and/or individual posts. For example, parallel rails can support crossing rows of deformable layer 34 materials, thus defining columns of pixels in trenches and/or cavities between the rails. Additional support posts within each cavity can serve to stiffen the deformable layer 34 and prevent sagging in the relaxed position.

The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C, as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIGS. 7A-7E, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties. Those skilled in the art will understand that in some embodiments, for example, the embodiments, illustrated in FIGS. 7A and 7B, the movable reflective layer 714 also acts as a deformable layer, in essence, an integrated movable reflective layer and deformable layer.

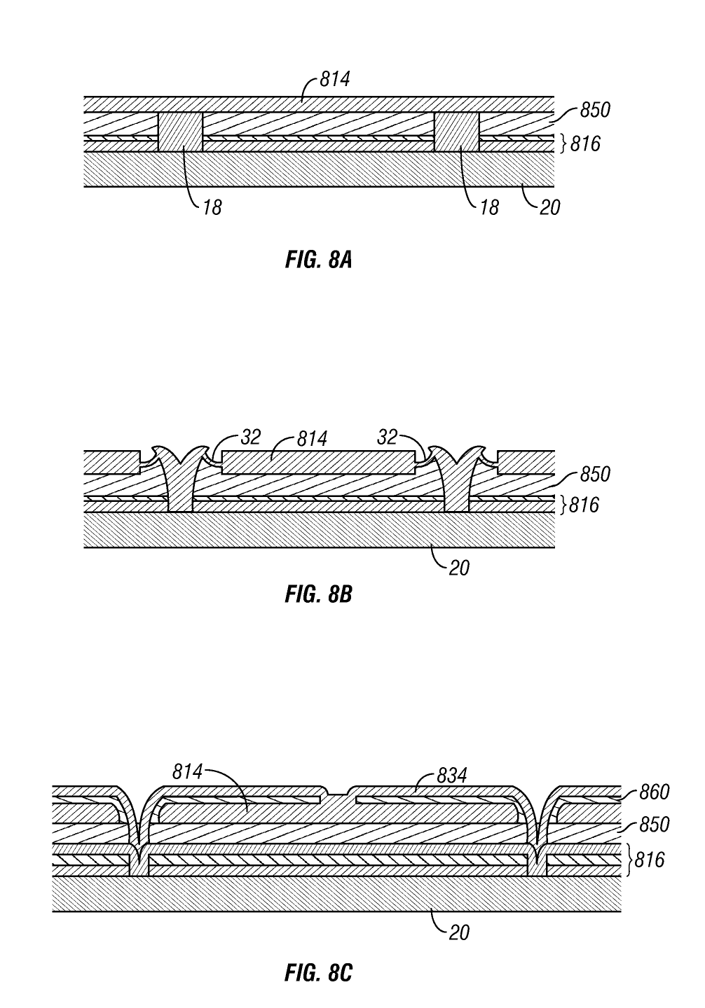

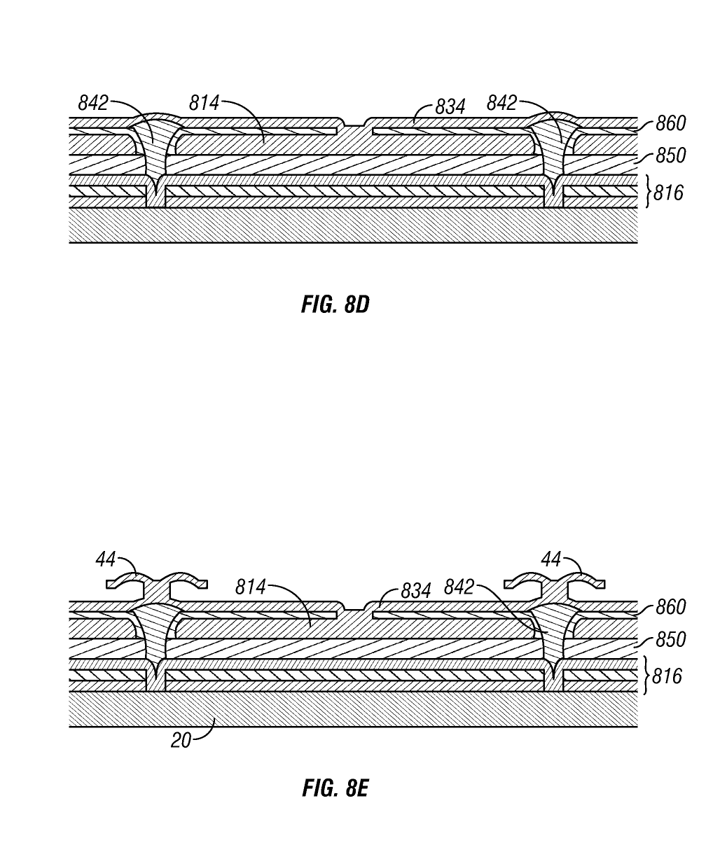

Embodiments of MEMS devices comprising movable components or elements are fabricated by a method in which a one or more sacrificial materials is removed or etched from a precursor structure, thereby creating a cavity or opening in the finished MEMS. Because such an etching step releases movable components from locked configurations in the precursor MEMS, such an etching step is referred to herein as a “release etch.” Accordingly, the precursor MEMS is also referred to as “unreleased” MEMS. Sacrificial structures comprising sacrificial materials serve as placeholders in the manufacture of the MEMS, for example, as patterned layers defining one or more voids, openings, and/or cavities in a MEMS. In particular, for electrostatic MEMS, sacrificial structures formed between stationary electrodes and movable electrodes occupy volumes that form cavities in the finished device. For example, FIGS. 8A-8E, illustrate unreleased interferometric modulators that correspond to the released interferometric modulators illustrated in FIGS. 7A-7E, respectively. The unreleased interferometric modulators 800 comprise a substrate 820 on which is formed an optical stack 816. A first sacrificial structure 850 is formed on the optical stack 816. A reflective layer 814 is formed on the sacrificial structure 850 and on support structures 818 that extend through the sacrificial structure 850. In the embodiments illustrated in FIGS. 8C-8E, a second sacrificial structure 860 is formed over the reflective layer 814, which is suspended from a deformable layer 834. In FIGS. 8A and 8B, the layer 814 represents both a deformable layer and a movable electrode or mirror. In FIGS. 8C-8E, the deformable layer 834 and movable electrode or mirror 814 are separate structures.

In some embodiments, the release etch comprises exposing the unreleased interferometric modulators to one or more etchants that selectively etch the first sacrificial structure 850 and, if present, the second sacrificial structure 860, thereby forming the cavities in the interferometric modulators illustrated in FIGS. 7A-7E, respectively, thereby releasing the reflective layer 814. In some embodiments, a plurality of suitable etchants is used to etch away the first sacrificial structure 850 and/or the second sacrificial structure 860 (if present). In some embodiments, the first and second sacrificial structures 850, 860 are etched contemporaneously, while in others, they are etched separately. Those skilled in the art will understand that the particular etchant or etchants used in a particular process will depend on the identities of the sacrificial materials in the MEMS, the identities of the structural materials, the structure of the MEMS, and the like.

In some embodiments, the release etch is performed using a vapor phase etchant that selectively etches both the first sacrificial structure 850 and the second sacrificial structure 860 (if present). The vapor phase etchant accesses the first sacrificial structure 850 and the second sacrificial structure 860 through one or more etch holes (not illustrated) formed in the deformable layer 834, through gaps between strips of the deformable layer 834, and/or from the sides of the device. In some preferred embodiments, the vapor phase etchant comprises fluorine-based etchants, and in particular, vapor phase xenon difluoride (XeF₂). At ambient temperature, xenon difluoride is a solid with a vapor pressure of about 3.8 Torr (0.5 kPa at 25° C.). Vapor from xenon difluoride selectively etches certain sacrificial materials, that is, without forming a plasma.

Those skilled in the art will understand that the materials comprising the sacrificial structures are selected in conjunction with structural and/or non-sacrificial materials of the device such that the sacrificial material(s) are selectively etched over the structural materials. In embodiments using XeF₂ as an etchant in the release etch, the sacrificial material may comprise at least one of silicon, germanium, titanium, vanadium, tantalum, molybdenum, tungsten, and mixtures, alloys, and combinations thereof; in some embodiments, molybdenum, tungsten, silicon, germanium, or silicon/molybdenum. In some embodiments, the sacrificial structure comprises an organic compound, for example, a polymer such as a photoresist. In some embodiments, a sacrificial structure comprises a single layer. In other embodiments, a sacrificial structure comprises a plurality of layers. Suitable structural materials are known in the art. Where the etchant comprises XeF₂, suitable structural materials resist etching by XeF₂, and include, for example, silica, alumina, oxides, nitrides, polymers, aluminum, nickel, chromium, and the like.

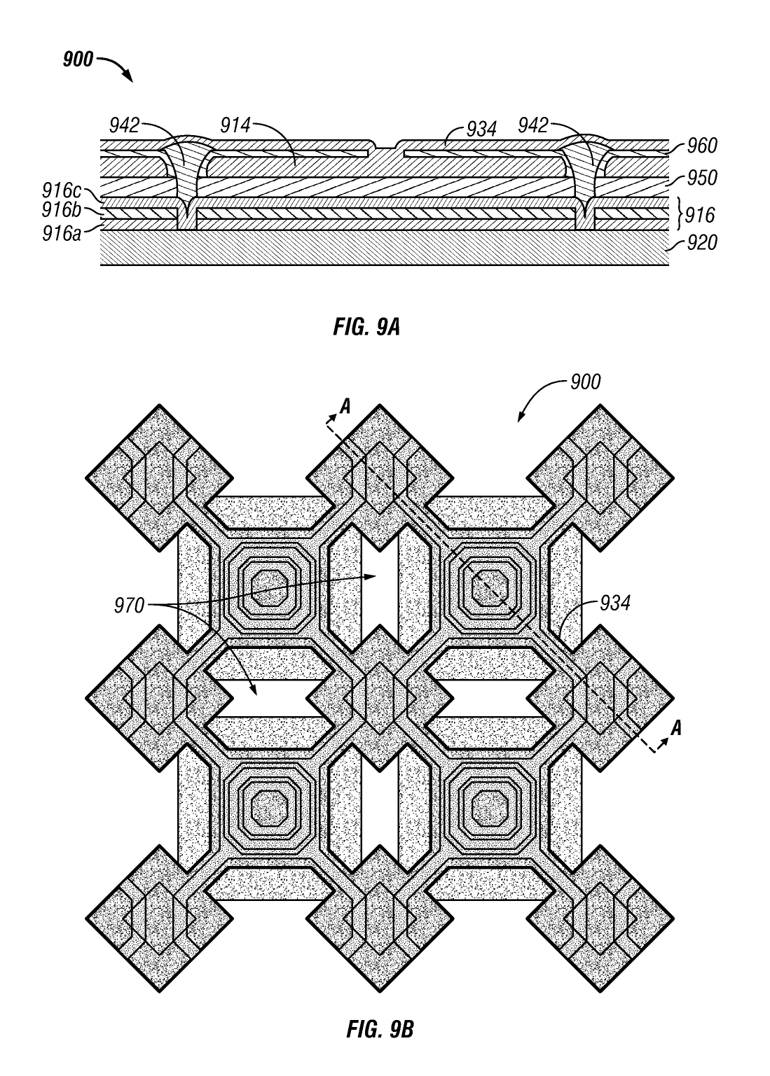

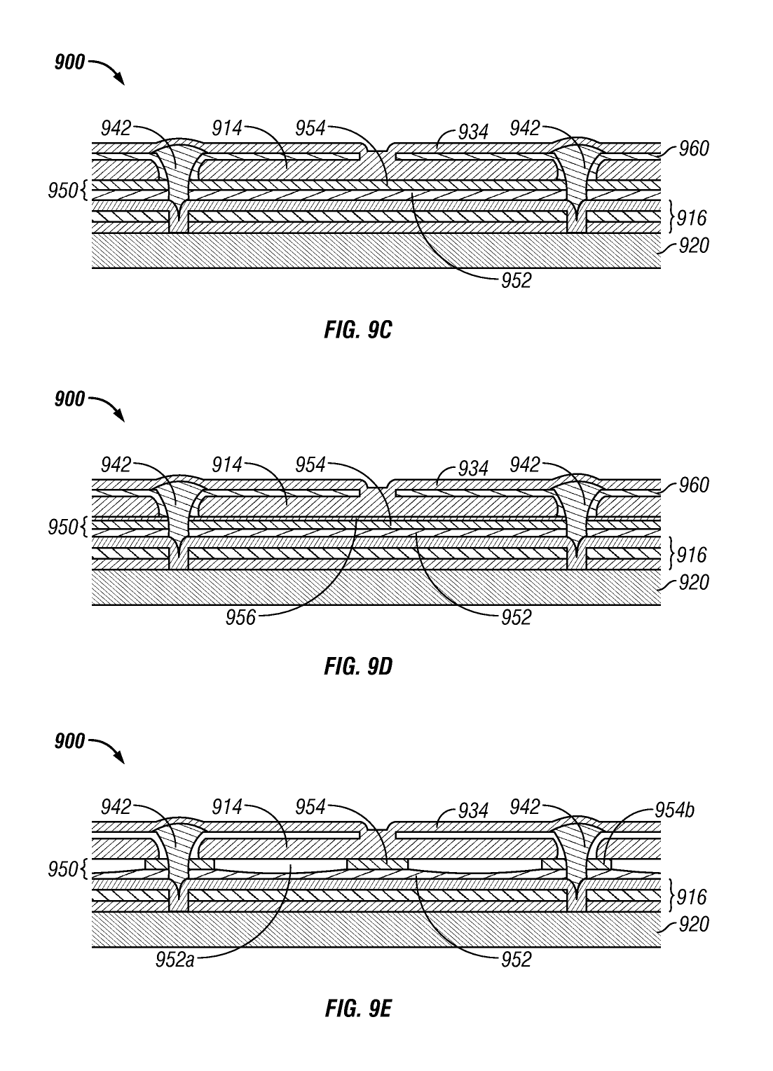

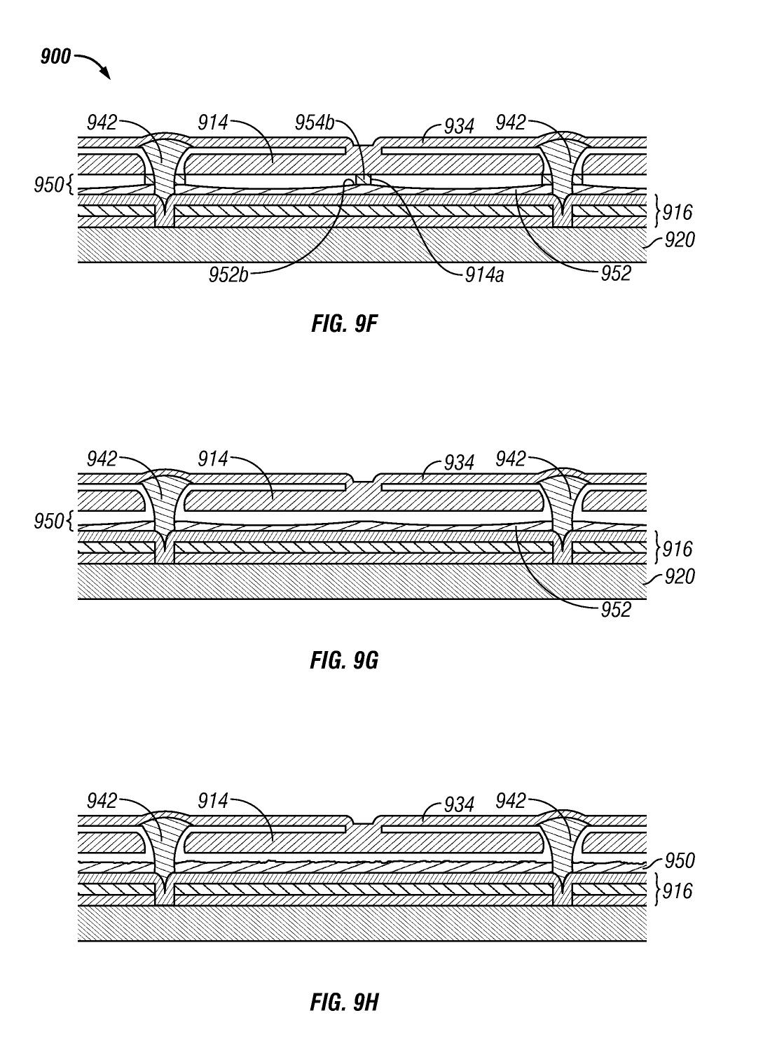

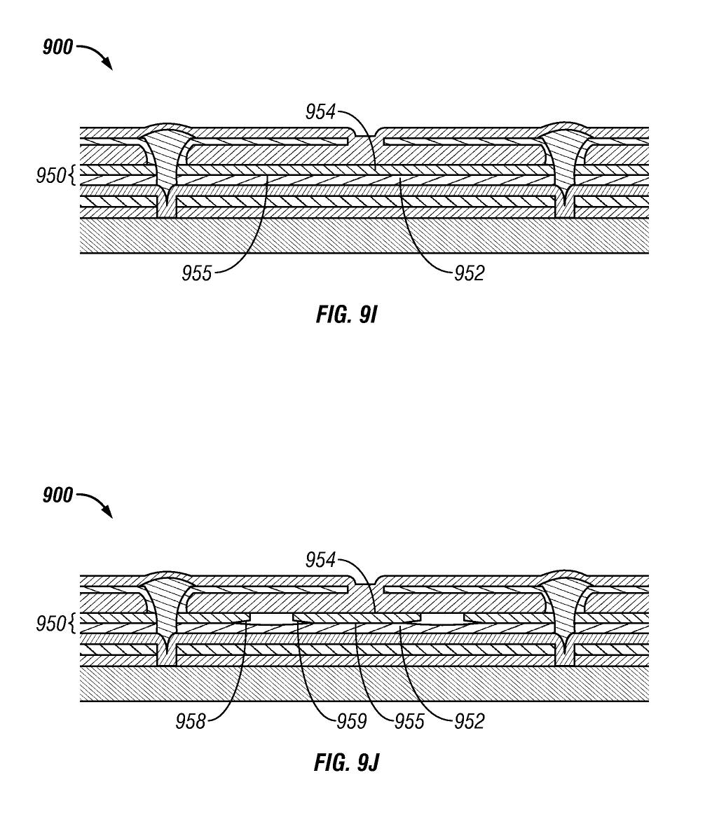

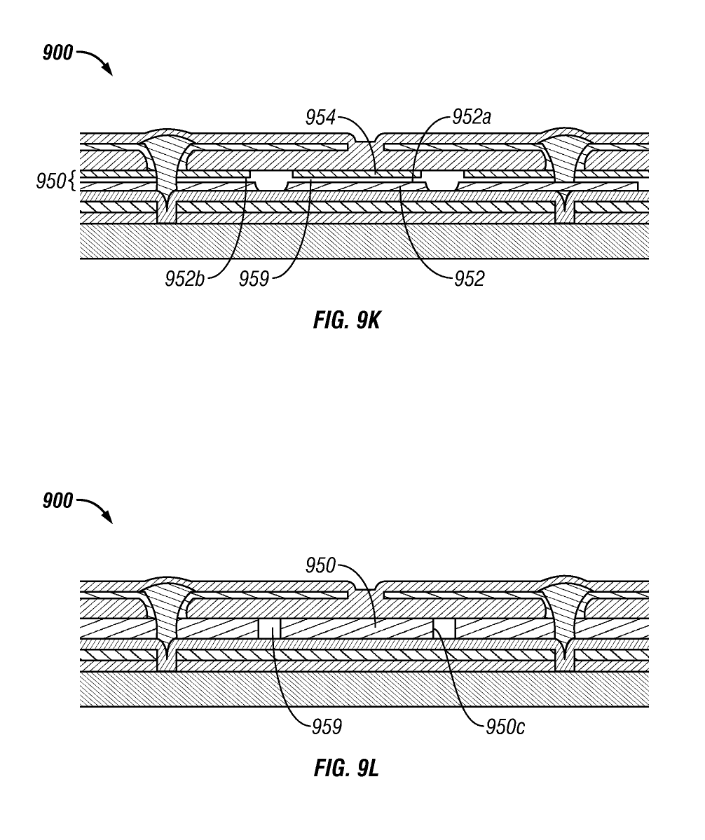

FIG. 9A illustrates a side cross-sectional view of an embodiment of an unreleased interferometric modulator 900 similar to the embodiment illustrated in FIG. 8D, which after release etching, provides a MEMS similar to the embodiment illustrated in FIG. 7D. Those skilled in the art will understand that certain features described with reference to the illustrated embodiment are also useful in other embodiments of interferometric modulators, including embodiments illustrated in FIGS. 7A-7C and 7E, as well as in other types of MEMS devices.

In the illustrated embodiment, the device 900 comprises a substrate 920 on which is formed an optical stack 916 comprising a conductive layer 916a, a partially reflective layer 916b, and a dielectric layer 916c. The optical stack 916 represents a lower stationary electrode of the MEMS device. A support structure illustrated as comprising a plurality of support post plugs 942 extends from the optical stack 916 and supports a deformable layer 934. A movable reflective layer 914, representing a movable electrode for the MEMS device, is secured to the deformable layer 934. A plurality of etchant access openings or etch holes 970 is formed in the deformable layer 934, as illustrated in FIG. 9B, which is a top view of an array of devices 900. Those skilled in the art will understand that other arrangements of etch holes are used in other embodiments.

Between the optical stack 916 and the movable reflective layer 914 is formed a first sacrificial structure 950, and between the movable reflective layer 914 and deformable layer 934 is formed a second sacrificial structure 960. Those skilled in the art will understand that other embodiments, for example, some embodiments corresponding to FIGS. 8A and 8B, comprise only a single sacrificial structure. In some embodiments, an aspect ratio between a length and/or width to a height of the first sacrificial structure 950 is greater than about 50:1, greater than about 100:1, greater than about 500:1, or greater than about 1000:1. In some embodiments, the ratio between a length and/or width of the movable reflective layer 914 and the thickness of the first sacrificial structure 950 is greater than about 50:1, greater than about 100:1, greater than about 500:1, or greater than about 1000:1.

In the illustrated embodiment, the first sacrificial structure 950 is compositionally non-uniform, for example, comprising at least a first portion (or component) and a second portion (or component). Each of the first portion and second portion comprises one or more sacrificial materials such that one of the first portion and second portion has a faster intrinsic etching rate, and is thereby selectively and/or differentially etchable over the other. Those skilled in the art will understand that many materials are etchable by a given etchant under specified conditions, but at rates too low for practical use in device manufacture. Accordingly, the term “etchable” as used herein refers to materials that a given etchant will etch at a useful rate for the manufacture of a device. In some embodiments, the first portion and second portion are different materials, each of which is etched by a different etchant. In some embodiments, the first portion and second portion are different materials, both of which are etchable by a common etchant. In some embodiments, the first and second portions comprise the same material, but with different etch rates. For example, in some embodiments, the first and second portions are formed or deposited with different levels of internal compression, density, and/or stress. Methods for fabricating materials with different levels of internal compression, density, and/or stress are known in the art, for example, by controlling deposition parameters including power, bias, pressure, flow, combinations, and the like. In some embodiments, the first and second portions are differently doped. In some embodiments, at least one of the first and second portion is modified, for example, by ion implantation, passivation, or the like.

In some preferred embodiments, one of the first portion and second portion is selectively etchable over the other using a single etchant, for example, XeF₂. As discussed above, sacrificial materials that are etchable by XeF₂ include silicon, germanium, titanium, vanadium, tantalum, molybdenum, tungsten, and mixtures, alloys, and combinations thereof; in some embodiments, molybdenum, tungsten, silicon, germanium, or silicon/molybdenum. Examples of comparative bulk etching rates for certain of these materials include W/Si, 2.5:1; Mo/Si, 6:1; Ti/Si, 85:1, Si/SiN, 1,000:1; Si/SiO₂, 10,000:1. In some embodiments, SiN and SiO₂ are used as etch stops for XeF₂, and are more rapidly etched using other etchants known in the art. Those skilled in the art will understand that other combinations of materials are also useful in other embodiments. Where the etchant is XeF₂, embodiments include combinations of first portions and second portions include, for example, W/Si, Mo/Si, Ti/Si.

In some embodiments of the first sacrificial structure 950, the first portion comprises at least two regions of a material formed under substantially the same or similar conditions and the second portion comprises an interface region between adjacent regions of the first portion. For example, in some embodiments, the first portion comprises the bulk of first and second layers, and the second portion comprises the interface region between the first and second layers. In other embodiments, the first portion comprises regions with another structure, for example, granules, rods, needles, or the like. Other embodiments comprise a combination of these configurations. Those skilled in the art will understand that the etch rate of the first portion regions will be substantially similar or identical. Nevertheless, some embodiments exhibit improved etching rates of the first sacrificial structure 950 compared with similar, single component sacrificial structures, as discussed in greater detail below.

Suitable sacrificial materials for the first portions are similar to the sacrificial materials discussed above for sacrificial components with different etching rates. In some embodiments, the sacrificial material(s) are etchable using a fluorine-based etchant (e.g. XeF₂), for example, comprising at least one of silicon, germanium, titanium, vanadium, tantalum, molybdenum, tungsten, and mixtures, alloys, and combinations thereof. In some embodiments the sacrificial material comprises molybdenum, tungsten, silicon, germanium, and/or silicon/molybdenum where the etchant comprises XeF₂.

It is believed that the interfacial layer that forms the second portion comprises adjacent surface layers of the first portions, as well as compounds formed on the surfaces of the adjacent surface layers, and any contaminants formed and/or deposited thereon. The topmost layer of a material typically has a higher free energy than the bulk. Because surface atoms have neighbors below and to the sides, but none above, the lattice distorts at the surface. The distortions typically propagate downward through a few layers of the material. These distortions increase the free energy of the top few layers of the material, thereby increasing the reactivity of the atoms in these layers. The topmost atoms also have “dangling bonds” because these atoms have no neighbors above them. Thus, the topmost atoms are extremely reactive, forming, for example, oxides, hydroxides, nitrides, carbides, fluorides, hydrides, and the like, depending on the compounds in the ambient environment. A new layer deposited over this surface layer will not be epitaxial unless the surface layer is scrupulously cleaned. Accordingly, the bottom-most atoms of the new layer are deposited over a relatively “dirty” surface, and likely react with the underlying surface, as well. This interfacial layer exhibits different etching characteristics than the bulk of the sacrificial layers.

In some embodiments, the first sacrificial structure 950 comprises a graded sacrificial layer, the composition of which changes from the first portion, to a mixture of the first and second portions, to the second portion. In some embodiments, the gradient between the first portion and the second portion is generally vertical, that is, with a higher concentration of one of the first and second portion at the top (e.g., proximal to the movable reflector 914) of the sacrificial structure 950 and a higher concentration of the other of the first and second portion at the bottom (e.g., proximal to the optical stack 916) of the sacrificial structure 950. Preferably, the faster etching of the first and second portion is disposed proximal to the etch holes 970 (FIG. 9B), which in the illustrated embodiment, are formed in the deformable layer 934. Any suitable formation method is used in fabricating the graded layer, for example, PVD-type, CVD-type, and ALD-type processes, as well as combinations, and the like.

In some embodiments, for example, the embodiment illustrated in cross section in FIG. 9C, the first portion of the first sacrificial structure 950 comprises a first sacrificial layer 952 and the second portion comprises a second sacrificial layer 954. In the illustrated embodiment, the first and second sacrificial layers 952, 954 are etchable by the same etchant, preferably, a vapor phase etchant, for example, XeF₂. In some embodiments, a faster etching sacrificial layer is disposed adjacent to a structural layer, for example, the movable reflector 914 and/or optical stack 916, as will be discussed in greater detail below. In some embodiments, the faster-etching sacrificial layer is disposed proximal to the etch holes 970 (FIG. 9B). Accordingly, in some embodiments, the second sacrificial layer 954 is etched faster than the first sacrificial layer 952. In the release etch, the etchant contacts the sacrificial structure 950 through etch holes 970 (FIG. 9B) in the deformable layer 934, as discussed above.

The relative thicknesses of the sacrificial layers 952 and 954 are selected according to factors known in the art, for example, the relative etch rates, the overall etch rate of the first sacrificial structure, the ease of forming each layer, deposition time for each layer, the thermal budget, residues left after etching, cost, and the like. In some embodiments, the relative thickness of the layers 952 and 954 are selected to provide early mechanical decoupling of the structural layers, for example, by selection of the particular materials for each layer based on the relative differences in their etch rates. In some embodiments, the relative thicknesses of the layers 952 and 954 are from about 1:100 to about 100:1, from about 10:90 to about 90:10, from about 20:80 to about 80:20, from about 40:60 to about 60:40, or about 50:50. Those skilled in the art will understand that the overall thickness of the combined sacrificial layers 952 and 954 will depend on factors including the color, if the device is an interferometric modulator, for example, from about 50 nm to about 300 nm, for example, about 100 nm.

In other embodiments, the first sacrificial structure 950 comprises other combinations of sacrificial layers, some of which are graded in some embodiments. For example, in some embodiments of the device 900 illustrated in FIG. 9C, at least one of the first and second sacrificial layers 952, 954 is a graded sacrificial layer. Other embodiments of the first sacrificial structure 950 comprise greater than two sacrificial layers, one or more of which may be graded. For example, the embodiment of the first sacrificial structure 950 illustrated in FIG. 9D comprises a first sacrificial layer 952, a second sacrificial layer 954, and a third sacrificial layer 956. As discussed above, in some embodiments, relatively faster etching sacrificial layers in the sacrificial structure 950 are disposed adjacent to structural elements, for example, the movable reflector 914 and optical stack 916. Accordingly, in some embodiments, at least one of the first and third sacrificial layers 952, 956 is etchable at a faster rate than the second sacrificial layer 954.

Each of the sacrificial layers, graded or non-graded, in the sacrificial structure 950 is formed by any suitable formation method, for example, one or more of PVD-type, CVD-type, and/or ALD-type processes, as well as by spin coating, combinations, and the like.

In some embodiments comprising a second sacrificial structure, for example, the second sacrificial structure 960 illustrated in FIG. 9C, the second sacrificial structure 960 has a non-uniform structure similar to that described above for the first sacrificial structure 950, for example, comprising one or more graded and/or non-graded sacrificial layers. In some embodiments, the second sacrificial structure 960 comprises a single layer of a sacrificial material.

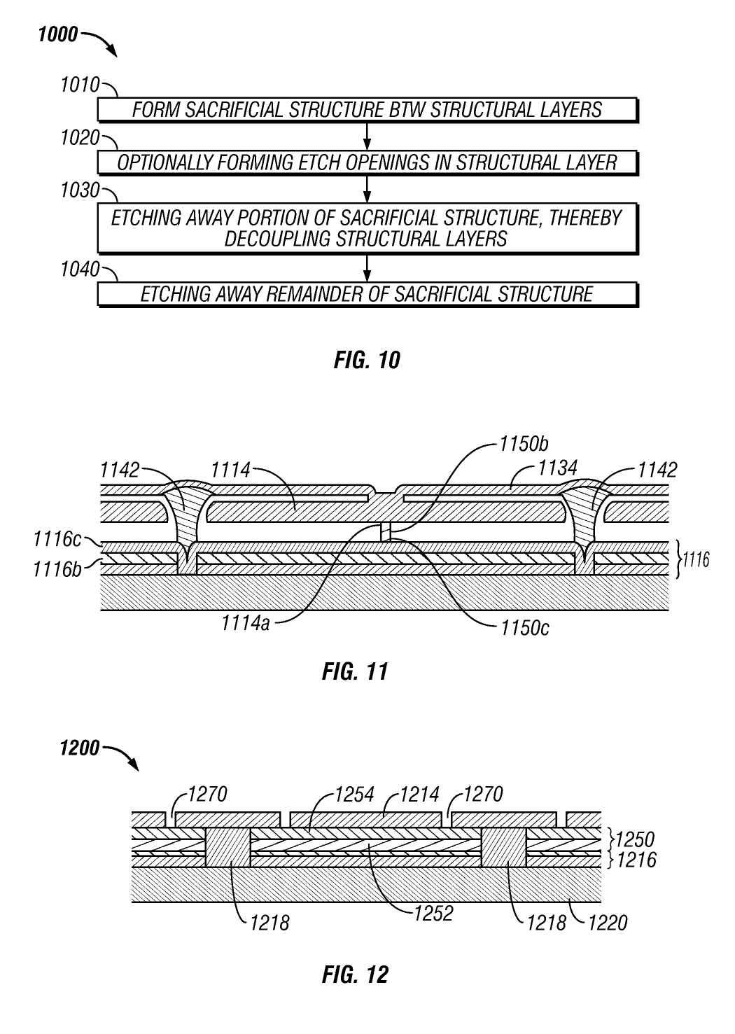

FIG. 10 is a flowchart illustrating an embodiment of a method 1000 for fabricating a MEMS with reference to the embodiments illustrated in FIGS. 9C-9G. Those skilled in the art will understand that the method 1000 is applicable to the manufacture of MEMS of other designs as well.

In step 1010, a sacrificial structure is formed between a first structural layer and a second structural layer. For example, in the embodiment illustrated in FIG. 9A, the first sacrificial structure 950 is formed over a plurality of structural features, for example, the substrate 920 and the optical stack 916. As discussed above, in the illustrated embodiment, the optical stack 916 in turn comprises three layers: a conductive layer 916a, a partially reflective layer or absorber 916b, and a dielectric layer 916c. The sacrificial structure 950 is formed as discussed above, for example, by PVD-type, CVD-type, and/or ALD-type processes, by spin coating, by combinations thereof, and the like. A second structural layer, for example, the deformable layer 934, is formed over the sacrificial structure 950. The illustrated embodiment also comprises a movable reflective layer 914, which is another structural feature formed over the sacrificial structure 950.

In optional step 1020, etch openings are formed in one of the structural layers. For example, FIG. 9B illustrates etch openings 970 formed in the deformable layer 934. The etch openings permit etchant access to at least a portion of the sacrificial structure.

In step 1030, the sacrificial structure is etched away, thereby mechanically decoupling the structural layers before the sacrificial structure is completely etched away. In some embodiments, the etchant selectively etches the sacrificial structure over structural layers and features under the etching conditions. In some embodiments, the same etchant etches both the first portion and the second portion of the sacrificial structure, although at different rates. Other embodiments use different etchants for the first portion and the second portion. For example, in some of these embodiments, only one of the first or second portion is etched in this step. In some embodiments, the etchant is a vapor-phase etchant, for example, XeF₂.

FIG. 9E illustrates in cross section the device 900 of FIG. 9C after partial release etching. In the illustrated embodiment, the second sacrificial structure has been completely etched away at this stage of the etching; in other embodiments, at least a portion of the second sacrificial structure remains unetched. At the illustrated stage of etching, portions of the second sacrificial layer 954 closest to the etch holes have been completely etched away. The remaining portions of the second sacrificial layer 954 that are relatively farther from the etch holes form the illustrated islands of sacrificial material. Similarly, portions of the first sacrificial layer 952a exposed to the etchant are starting to etch. Those skilled in the art will understand that the relative degree of etching between the first sacrificial layer 952 and second sacrificial layer 954 will depend on their relative etching rates by the selected etchant under the etching conditions.

It is believed that the etching occurs along an etch front that propagates horizontally and vertically along the interfaces between dissimilar materials, for example, the second sacrificial layer 954 and the bottom of the movable reflective layer 914. Behind the etch front, the bulk sacrificial layer 954 is etched, thereby forming the islands illustrated in FIG. 9E. Those skilled in the art will understand that an etch rate of a material at an etch front does not necessarily correlate to the etch rate of the bulk material.

FIG. 9F illustrates the device 900 further along the etching process. In the illustrated embodiment, some unetched portions of the second sacrificial layer form pillars 954b extending between the deformable layer 914 and the first sacrificial layer 952.

In some embodiments, the pillar 954b becomes decoupled mechanically from at least one adjacent layer at this stage, for example, in the illustrated example, the movable reflective layer 914 or the first sacrificial layer 952. Accordingly, structural layers above the second sacrificial layer 954 are mechanically decoupled from structural layers below the second sacrificial layer. As the second sacrificial layer 954 etches, stresses in the MEMS 900 between relatively movable components of the MEMS, in the illustrated example, components above the second sacrificial layer 954 (e.g., the movable reflective layer 914, the deformable layer 934) and the components below the second sacrificial layer 954 (e.g., the first sacrificial layer 952, the optical stack 916, the substrate 920), are concentrated or focused at the pillar 954b. In some embodiments, a stress, for example, a shear and/or tensile stress, induces mechanical separation between the pillar 954b and an adjacent layer or structure, for example, at least one of the movable reflective layer 914 and the first sacrificial layer 952 in the illustrated embodiment.

For example, in some embodiments, the material of the pillar 954 does not adhere well to the material an adjacent layer, for example, of the movable reflective layer 914. The stress between these components causes a mechanical separation between the pillar 954b and the movable reflective layer 914, for example, at their interface at the top 914a of the pillar. In embodiments in which the movable reflective layer 914 comprises aluminum and/or aluminum alloy, suitable weakly adhesive materials for the second sacrificial layer 954 include germanium and molybdenum oxide. Those skilled in the art will understand that other materials are useful in other embodiments, and that the particular material will depend on the material to which the weakly adhesive layer is adjacent, the etching system, and the like. In some embodiments, the pillar 954b and first sacrificial layer 952 become mechanically decoupled at this stage at the bottom 952b of the pillar, that is, from the first sacrificial layer 952. In some embodiments, the first sacrificial layer 952 adheres weakly to the dielectric layer 916c, thereby facilitating mechanical decoupling between these layers. In some embodiments, each of the first and second sacrificial layers 952 and 954 weakly adheres to an adjacent layer, for example, a structural and/or sacrificial layer. In other embodiments, the sacrificial structure 950 comprises a single layer that weakly adheres to at least one adjacent layer, for example, the movable reflective layer 914 and/or dielectric layer 916c.

Those skilled in the art will understand that a weakly adhering layer adheres sufficiently to an adjacent layer to permit fabrication of the device, but has sufficiently poor adhesion to decouple from the adjacent layer during etching. As discussed above, the decoupling occurs as the contact area between the weakly adhering layer and the adjacent is reduced as the weakly adhering layer is etched into islands and/or pillars. As the etching proceeds, the overall stress between the layers remains constant, thereby concentrating the stress on the islands and/or pillars. At some point, the stress overcomes the adhesion between the layers and the layer decouple.

In other embodiments, the pillar 954b does not become mechanically decoupled from an adjacent layer at the illustrated stage of etching.

FIG. 9G illustrates the device 900 further along in the etching process. At the illustrated stage of etching, the second sacrificial layer 954 is substantially completely etched away, thereby mechanically decoupling the layers above the second sacrificial layer (e.g., the movable reflective layer 914, the deformable layer 934) from the layers below the second sacrificial layer (e.g., the first sacrificial layer 952, the optical stack 916, the substrate 920). In the illustrated embodiment, substantial portions of the first sacrificial layer 952 remain unetched, although in other embodiments, more of the first sacrificial layer 952 is etched away at this stage.

In step 1040, the remainder of the sacrificial structure is etched away, using either the same etchant or a different etchant. In the device illustrated in FIG. 9G, etching away the remainder of the first sacrificial layer 952 provides a device similar to that illustrated in FIG. 7D.

The method 1000 is also useful in manufacturing a MEMS using a device in which the sacrificial structure comprises a graded layer, for example, as illustrated in FIG. 9A. For example, in an embodiment in which a graded first sacrificial structure 950 comprises a faster etching composition at the top and a slower etching composition at the bottom, in step 1030, the top of the sacrificial structure 950 etches relatively rapidly horizontally and relatively slowly vertically, thereby providing the sacrificial structure 950 illustrated in FIG. 9H. Completing the etching in step 1040 provides a device similar to that illustrated in FIG. 7D. Those skilled in the art will understand that the method 1000 is also useful for release etching MEMS devices comprising a sacrificial structure comprising combinations of graded and non-graded layers, and/or comprising greater than three sacrificial layers, as described above.

The method 1000 is also applicable to manufacturing a MEMS device from embodiments of unetched MEMS devices comprising a first sacrificial structure comprising a first portion of at least two regions of a material formed under substantially the same or similar conditions, and a second portion comprising an interface region between adjacent regions of the first portion. In step 1010, a sacrificial structure is formed between structural layers. For example, an embodiment of the unetched MEMS device 900 illustrated in FIG. 9I is similar to the device illustrated in FIG. 9C, and comprises a first sacrificial structure 950 comprising a first sacrificial layer 952 and a second sacrificial layer 954 corresponding to the first portion, and an interface or interfacial layer 955 between the first 952 and second 954 sacrificial layers. Those skilled in the art will understand that some embodiments of the sacrificial structure 950 comprise more than two sacrificial layers. The first 952 and second 954 sacrificial layers comprise substantially the same sacrificial material formed under substantially the same conditions in the illustrated embodiment. The first sacrificial structure 950 is disposed between an optical stack 916 and a movable reflective layer 914. The first 952 and second 954 sacrificial layers are formed using any suitable method, for example, by sputtering, physical vapor deposition-type processes, chemical vapor deposition-type processes, atomic layer deposition-type processes, molecular beam epitaxy, combinations thereof, and the like. In some embodiments, the device is cleaned before and/or after depositing one or more of the sacrificial layers.

Optional etching holes are formed in step 1020, which are not visible in the section of the embodiment illustrated in FIG. 9I.

In step 1030 the first sacrificial structure 950 is etched using a suitable etchant. Suitable etchants and sacrificial materials are discussed above. For example, in some embodiments, the etchant comprises XeF₂ and the sacrificial materials comprise molybdenum. FIG. 9J illustrates an intermediate structure in which the second sacrificial layer 954 is etched through to the first sacrificial layer 952 and an etch front 958 propagates rapidly along an interface 955 between the first 952 and second 954 sacrificial layers, thereby forming a gap 959 therebetween. Etching of the bulk sacrificial material in the first 952 and second 954 sacrificial layers is slower. In FIG. 9K, etching of the interface 955 is complete, and the resulting gap 959 mechanically decouples the first sacrificial layer 952 from the second sacrificial layer 954.

The remaining portions of the first 952 and second 954 sacrificial layers are etched away in step 1040 to provide the released MEMS illustrated in FIG. 7D. Some embodiments of this method exhibit at least one of faster etching rates or reduced etchant usage for etching away the entire first sacrificial structure. It is believed that the improved etching rates result from faster etching at the interface(s) or seams between the first and second portions, thereby exposing larger surfaces of the first and second portions to the etchant than would be exposed in the etching of a monolithic sacrificial structure. Although the precise mechanism for the faster etching at the interface 955 has not yet been determined, it is believed that surface strain of each layer as well as compounds formed on the surfaces and contaminants trapped therein makes the interface more prone to etching.

For example, in the embodiment illustrated in FIGS. 9J and 9K, the gap 959 between the first 952 and second 954 sacrificial layers, formed by rapid etching of the interface 955 between the first 952 and second 954 sacrificial layers, exposes horizontal surfaces 952a and 954b to the etchant, thereby increasing the overall etching rate. In contrast, FIG. 9L illustrates an embodiment of a similar partially etched MEMS device in which the first sacrificial structure comprises a single sacrificial layer. In the illustrated embodiment, the first sacrificial structure 950 is partially etched, forming openings 959 with etchant accessible surfaces 950c, which have a smaller area than the surfaces 952a and 954b. All other things being equal, the increased etchant accessible area in results in a faster etching rate of the first sacrificial structure 950 in the embodiments illustrated in FIGS. 9I-9K compared with the embodiment illustrated in 9L.

Reduced etchant usage is believed to be related to increased etching rate in some embodiments. In any etching process, some portion of the etchant will react at a relatively slow rate with one or more materials other than the sacrificial material(s) of the sacrificial structure(s), for example, contaminants in the etching apparatus, structural materials in the MEMS, and the like. By increasing the overall etching rate of the sacrificial material(s), contact time between the etchant and the slower etching materials is reduced, thereby reducing the amount of etchant consumed in this unproductive etching process.

FIG. 11 illustrates a cross section of a partially etched MEMS 1100 similar to the device illustrated in FIG. 9F, except that the first sacrificial structure 1150 comprises a single component instead of a plurality of components, for example, a layer comprising single sacrificial material. In the illustrated embodiment, a pillar 1150b of the unetched sacrificial material extends between the optical stack 1116 and the movable reflective layer 1114. As discussed above, as the etching proceeds, relatively movable components of the MEMS become free to move. This motion induces stress at those components of the MEMS that remain relatively immobile, for example, the unetched portions of the sacrificial structure 1150. As material from the first sacrificial structure 1150 is etched, the first sacrificial structure 1150 changes from a layer, to islands, to pillars 1150b illustrated in FIG. 11. As the sacrificial structure 1150 gets smaller, the stresses get larger, because the relative motion of the movable components increases, and become more concentrated, in particular, at the top 1114a of the pillar and at the bottom 1150c of the pillar. Because the relative motion in the device is vertical, the stress typically includes compressive or tensile components. In some cases, the stress is sufficient to cause mechanical failure, which can be manifested as damage to one or more of the structural elements of the MEMS, for example, the optical stack 1116 or the movable reflective layer 1114. In particular, damage to the optical stack 1116 typically involves damage to the dielectric layer 1116c, for example, as a crack or break. A break in the dielectric layer 1116c, in turn, could permit contact between an etchant and structures and/or layers below the dielectric layer 116c, for example, the partial reflective layer 1116b. Depending on the identities of the etchant and the material of the partial reflective layer 1116b, in some embodiments, the partial reflective layer is etched and thereby damaged to at least some extent by the etchant after the break or damage to the dielectric layer 1116c. Even in cases in which the partial reflective layer 1116b is resistant to the etchant, because of the thinness of the partial reflective layer 1116b, any etching can be problematic to its proper function.

In some embodiments of arrays of MEMS, the relative motion is greatest at a free edge of a deformable layer, and consequently, damage is most likely at the free edge. In some embodiments, an array or subarray of MEMS shares a deformable layer. A free edge is an edge that is not shared, typically, at the edge of the array or subarray.

One technique for reducing the potential for damage created by the formation of pillars 1150b in the etching of the sacrificial structure 1150 is through modifying the etch holes, for example, increasing total area of the etch holes. The total area of the etch holes may be increased by changing their dimensions, for example, changing their shapes and/or increasing their sizes. The total area can also be increased by increasing the number of etch holes. For example, some embodiments comprise a large number of etch holes with variable dimensions, which provide fast and controlled etching of the sacrificial structure(s). Without being bound by any theory, it is believed that increasing the total area of the etch holes increases the etch rate of the sacrificial structure 1150. It is believed that in fast-etching embodiments, pillars formed in the etching of the sacrificial structure 1150 are etched away before they can damage the device. In some embodiments, however, increasing the areas of the etch holes reduces the mechanical performance of the deformable layer 1134 in which they are formed. In some embodiments, a deformable layer having a large total area of etch holes increases the electrical resistance of the deformable layer 1134. In some embodiments, a deformable layer having a large total area of etch holes negatively affects optical performance of an optical device, for example, reducing the contrast ratio. Furthermore, large and/or numerous etch holes reduce the fill factor of the MEMS in an array in some embodiments.

In some embodiments, the etch holes are positioned such that any etching-induced damage to the device is directed to non- or less critical portions of the device. In some embodiments, however, it is not practical to prevent pillar formation in the etching reaction from certain areas in the device. In some embodiments, certain regions of the deformable layer 1134 are not appropriate for forming etch holes. Providing non-critical areas can also reduce the fill factor in an array of MEMS.

In some embodiments, the sacrificial structure 1150 is made using a fast etching material, which, as discussed above, is believed to etch away before appreciable damage is done to the device. Some embodiments of fast-etching materials appear to form residues on etching that induce stiction in the finished device.

In contrast, embodiments of a MEMS comprising a sacrificial structure as described exhibit some combination of fewer etch holes, smaller etch holes, mechanically more robust deformable layers, higher fill factors, and reduced stiction.

### Example 1

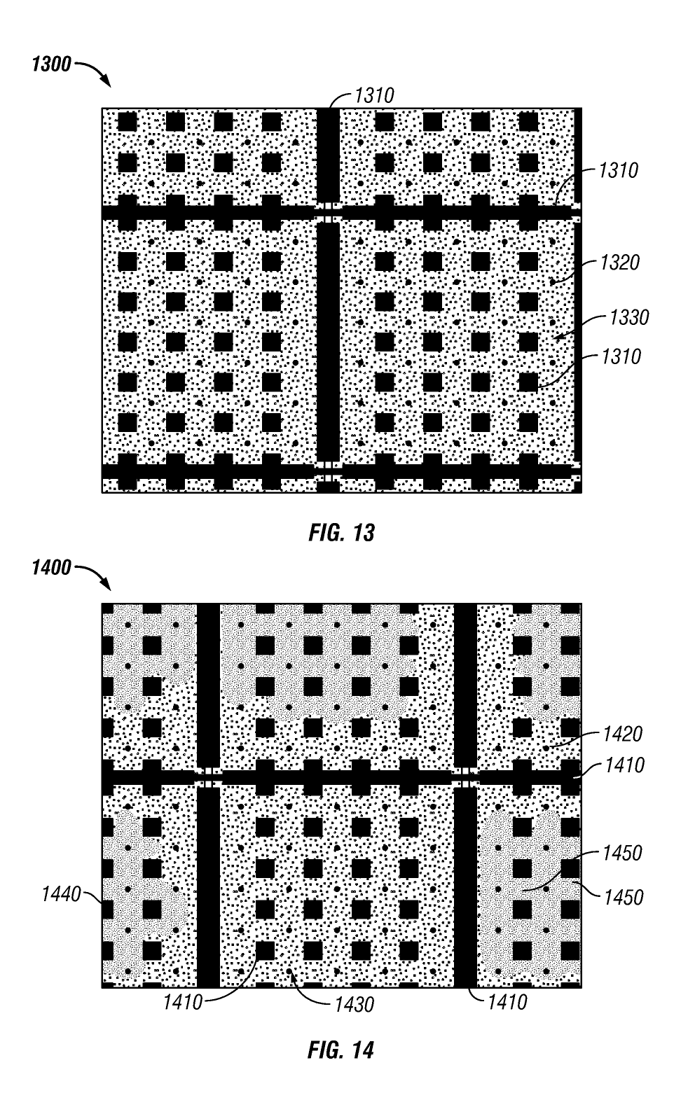

An 5×6 array of unreleased interferometric modulators was manufactured similar to the embodiment schematically illustrated in cross section in FIG. 12. The unreleased interferometric modulators 1200 comprise a 37 cm 47 cm borosilicate glass substrate 1220 (about 0.7 mm thick), on which is formed an optical stack 1216 comprising an indium tin oxide (ITO) layer (about 0.5 μm), a chromium layer (about 0.006 μm), and a silicon dioxide layer (about 0.05 μm). A sacrificial structure 1250 comprising a first sacrificial layer 1252 and a second sacrificial layer 1254 was formed over the optical stack. An aluminum movable reflective layer 1214 (about 0.03 μm) was formed over the sacrificial structure 1250. Etch holes 1270 are formed in the movable reflective layer 1214. Silica support posts 1218 were formed that extended between the substrate 1220 and the movable reflective layer 1214. The lower, first sacrificial layer 1252 comprised an about 50 nm thick layer of molybdenum, and the upper, second sacrificial layer 1254 comprised an about 50 nm thick layer of germanium and/or silicon, both layers deposited by PVD. After etching with XeF₂ vapor (10 cycles of 120 s), all of the sacrificial structure was etched away. FIG. 13 is a view through the substrate of a portion of the array 1300 showing black masks 1310 and etch holes 1320. The sacrificial material in the light-colored areas 1330 have been etched away.

### Example 2

An array of unreleased interferometric modulators similar to those in EXAMPLE 1 was manufactured with a sacrificial structure comprising a single layer of molybdenum deposited by PVD. After etching with XeF₂ vapor (10 cycles of 120 s), pillars of molybdenum remained, as well as some partially etched regions. FIG. 14 is a through-substrate view of the array 1400 showing black masks 1410 and etch holes 1420. The light-colored areas 1430 are fully etched. Darker areas 1440 are partially etched. Pillars 1450 of molybdenum are observable around some of the black masks 1410.

### Example 3

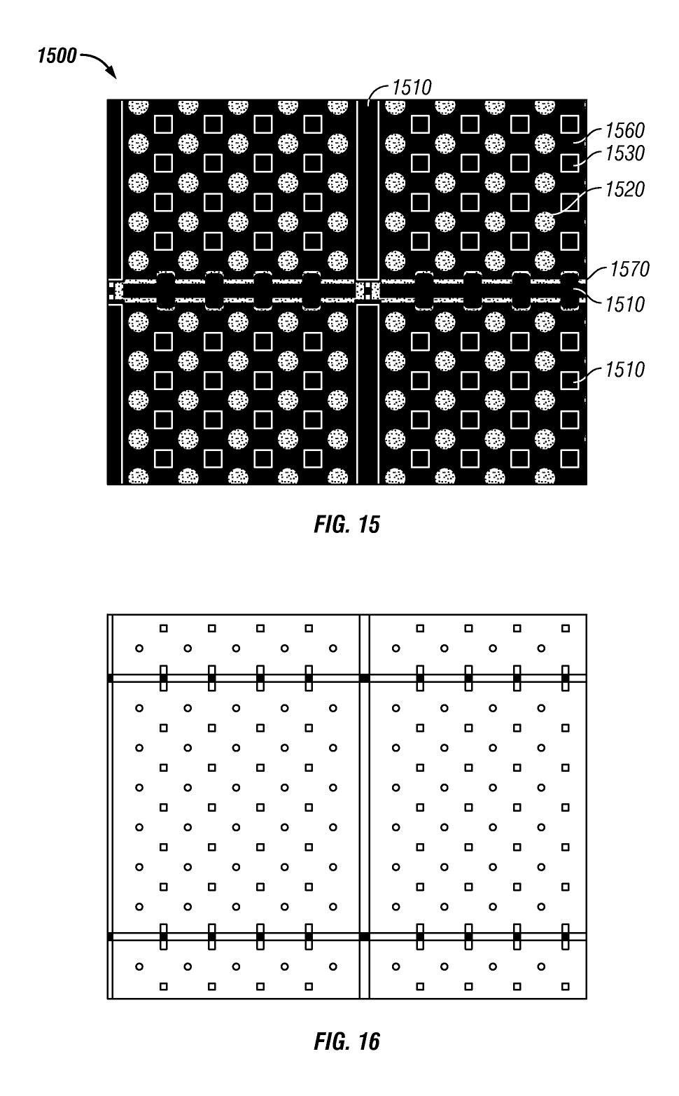

An array of unreleased interferometric modulators similar to those in EXAMPLE 1 was manufactured with a sacrificial structure comprising a single layer of molybdenum deposited by PVD. After etching with XeF₂ vapor (5 cycles of 120 s), the sacrificial layer was etched only under the etch holes. FIG. 15 is a through-substrate view of the array 1500 showing black masks 1510 and etch holes 1520 and the free edge 1570 of the deformable layer. The light-colored circular areas 1530 around the etch holes 1520 are etched. Dark areas 1560 are unetched.

### Example 4

An array of interferometric modulators similar to those of EXAMPLE 1 was manufactured with a sacrificial structure comprising a single layer of germanium and an aluminum movable reflective layer. Etching with XeF₂ vapor (5 cycles of 120 s) provided full release with no damage to the optical stack. FIG. 16 is a through-substrate view of the etched array after etching showing no defects in the optical stack. It is believed that the germanium sacrificial structure adheres weakly to the movable reflective layer, and consequently, mechanically decouples these layers, thereby preventing damage to the interferometric modulator in the etching.

### Example 5

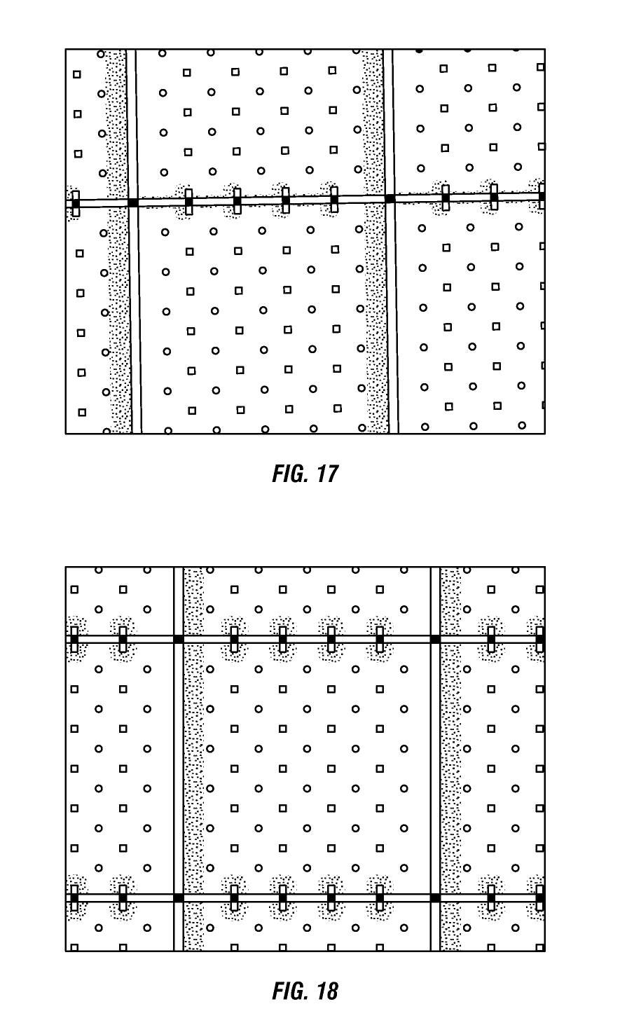

An array of interferometric modulators similar to those of EXAMPLE 1 was manufactured with a sacrificial structure comprising a molybdenum first sacrificial layer (about 50 nm thick) and a germanium second sacrificial layer (about 50 nm thick). The movable reflective layer was aluminum. The array was etched with XeF₂ (5 cycles of 120 s), which provided full release with no damage to the optical stack, as shown in the through-substrate view of the etched array in FIG. 17. It is believed that poor adhesion between the germanium layer and the aluminum movable reflective layer prevents damage in the etching.

### Example 6

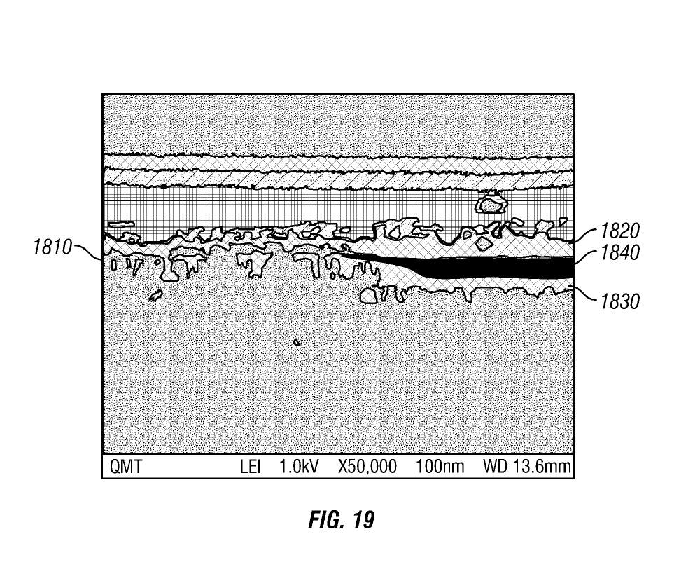

An array of interferometric modulators similar to those of EXAMPLE 1 was manufactured with a sacrificial structure comprising a molybdenum first sacrificial layer (about 50 nm) and a molybdenum oxide second sacrificial layer (about 50 nm thick). The movable reflective layer was aluminum. FIG. 18 is an scanning electron micrograph showing the interface 1810 between the molybdenum oxide layer 1820 and the movable reflective layer 1830. The gap 1840 between the two layers indicates poor adhesion between these materials. The array was etched with XeF₂ (5 cycles of 120 s), which provided full release with no damage to the optical stack, as shown in the through-substrate view of the etched array in FIG. 19. It is believed that poor adhesion between the molybdenum oxide layer and the aluminum movable reflective layer prevents damage in the etching.

### Example 7

Unreleased interferometric modulators arrays similar to those in EXAMPLE 1 were manufactured with one-layer, two-layer, and three-layer sacrificial structures, where each layer was molybdenum deposited by PVD under identical conditions. The underlying surface was cleaned before depositing each layer of molybdenum by PVD. Cleaning was performed by thermal degas, ion sputtering, or N₂O plasma. The thicknesses of each sacrificial layer are provided in TABLE 1.

TABLE 1

| | 1-Layer | 2-Layer | 3-Layer |
|---|---|---|---|
| First layer | 1,980 Å | 1,100 Å | 660 Å |
| Second layer | | 880 Å | 660 Å |
| Third layer | | | 660 Å |
| Total | 1,980 Å | 1,980 Å | 1,980 Å |

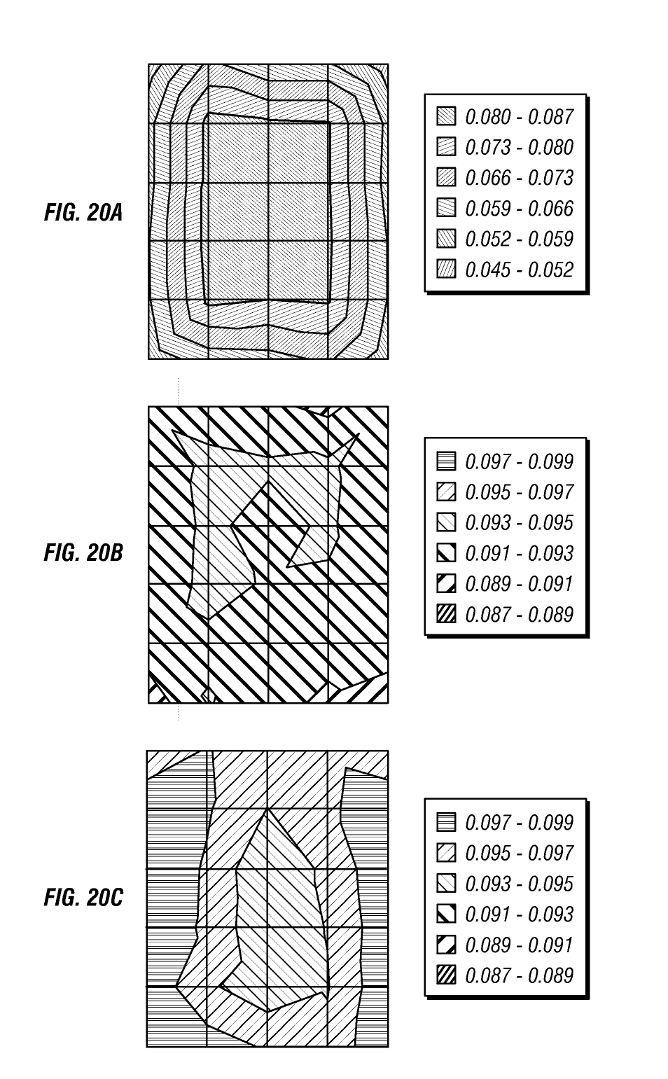

A “release radius” is the radius of an etched portion of the sacrificial structure around an opening through which etchant contacts the sacrificial structure, for example, an etch hole. Accordingly, larger release radii correlate with faster etching. FIGS. 20A, 20B, and 20C illustrate representative release radius contour maps for one array of each type after 14 XeF₂ etching cycles. Each hatching level is a 0.002 mm radius contour. The map for the single-layer sacrificial structure illustrated in FIG. 20A shows faster etching at the center and slower etching at the edges with a pronounced radial gradient, spanning six different release radius levels. The map for the two-layer sacrificial structure illustrated in FIG. 20B exhibits more uniform etching over the entire array, with a slight bias toward the center. The map of three-layer sacrificial structure illustrated in FIG. 20C also exhibits more uniform etching compared with the single-layer, with a slight bias toward the edges. Etching rates increased as followings: three-layer sacrificial structure>two-layer sacrificial structure>>one-layer sacrificial structure.

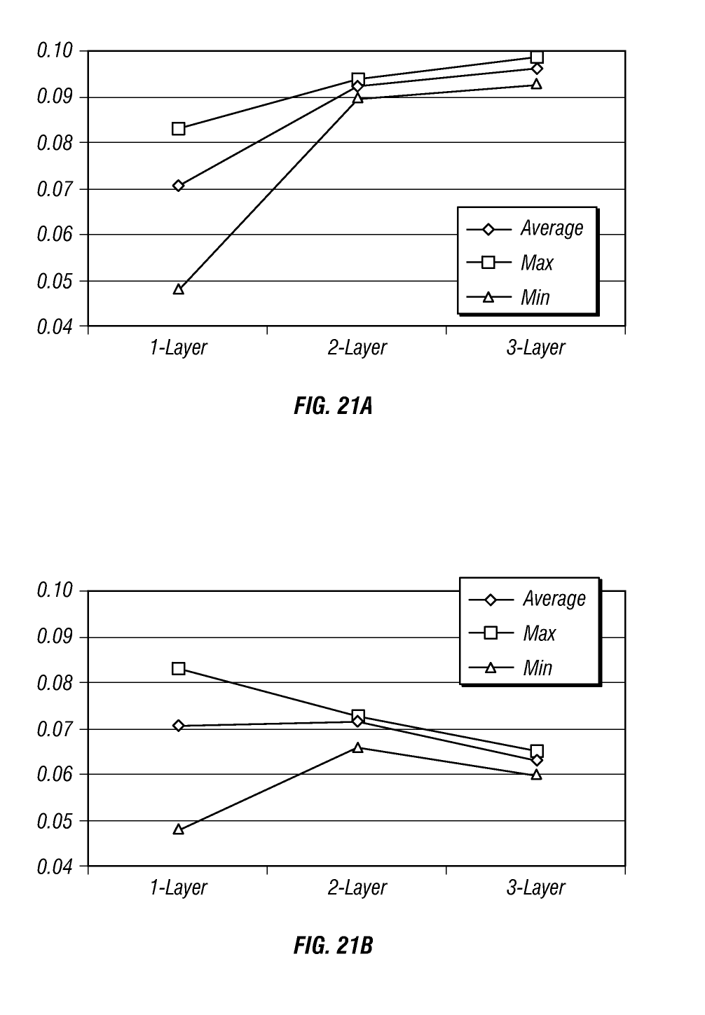

Mean release radii values were then calculated for each array. FIG. 21A illustrates average, minimum, and maximum values for several arrays of each type, again showing that the three-layer sacrificial structure is faster than the two-layer, which is, in turn, much faster than the one-layer. The multilayer sacrificial structures also exhibited reduced substrate-to-substrate variation, which can improve process uniformity.

FIG. 21B illustrates the average, minimum, and maximum release radii values determined as discussed above, where the number of etching cycles for each type of sacrificial structure was selected to provide similar averages. Similar release radii resulted after 14 etching cycles for one-layer sacrificial structures, 11 cycles for two-layer sacrificial structures, and 10 cycles for three-layer sacrificial structures. Again, both multilayer sacrificial structures exhibited both faster etching and improved uniformity compared with the single-layer sacrificial structure.

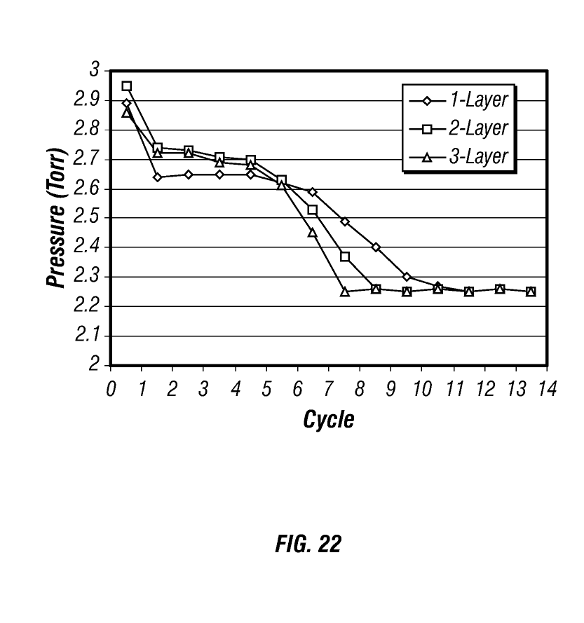

The correlation between etch cycle and the pressure in the etching tool is illustrated in FIG. 22 for arrays comprising one-layer, two-layer, and three-layer sacrificial structures. The pressure in the etching chamber increases during etching according to the following equation:

Mo(s)+3XeF₂(g)→MoF₆(g)+Xe(g)

Accordingly, etching is complete when the pressure drops to a stable value. Etching of the three-layer sacrificial structure was complete after about 8 etching cycles, while the two-layer was complete after about 9 cycles, and the one-layer was complete after 12 cycles.

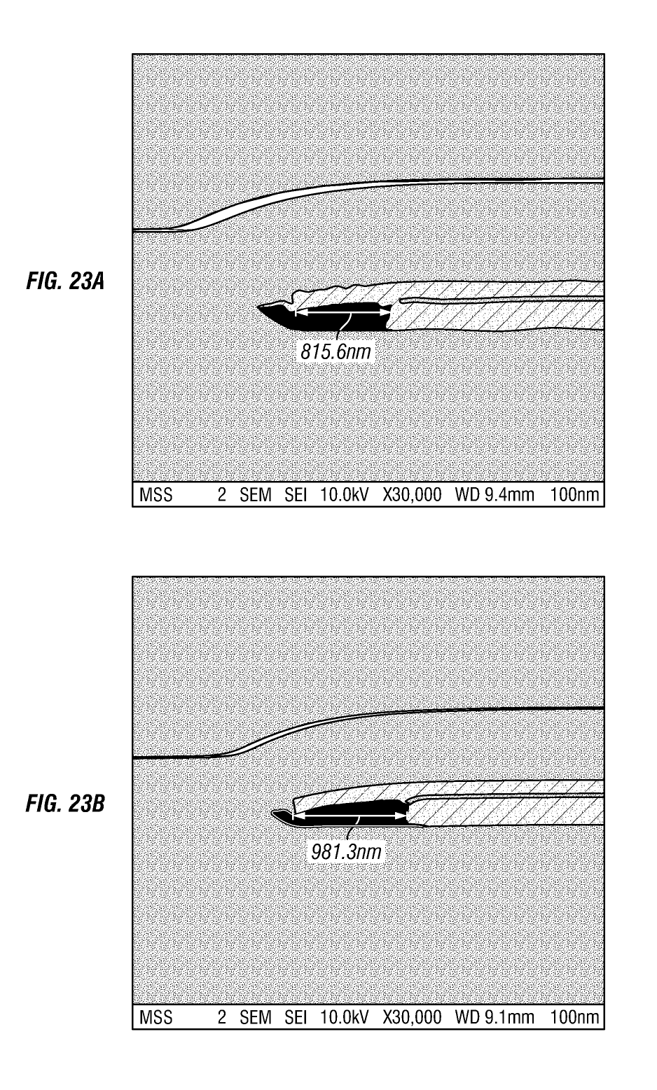

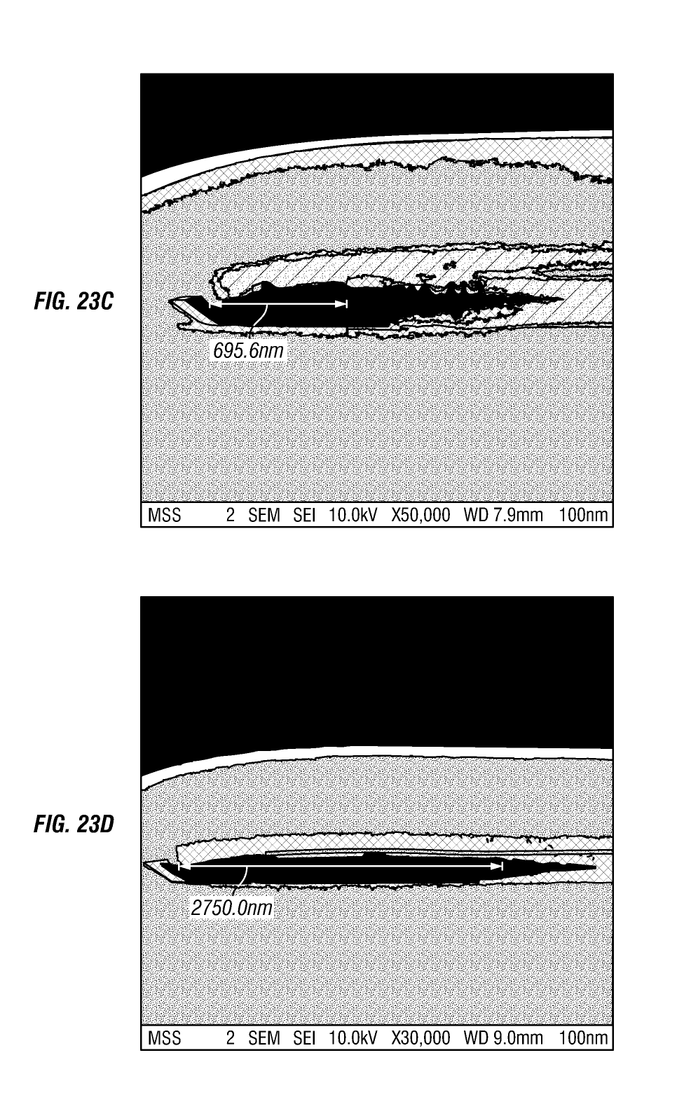

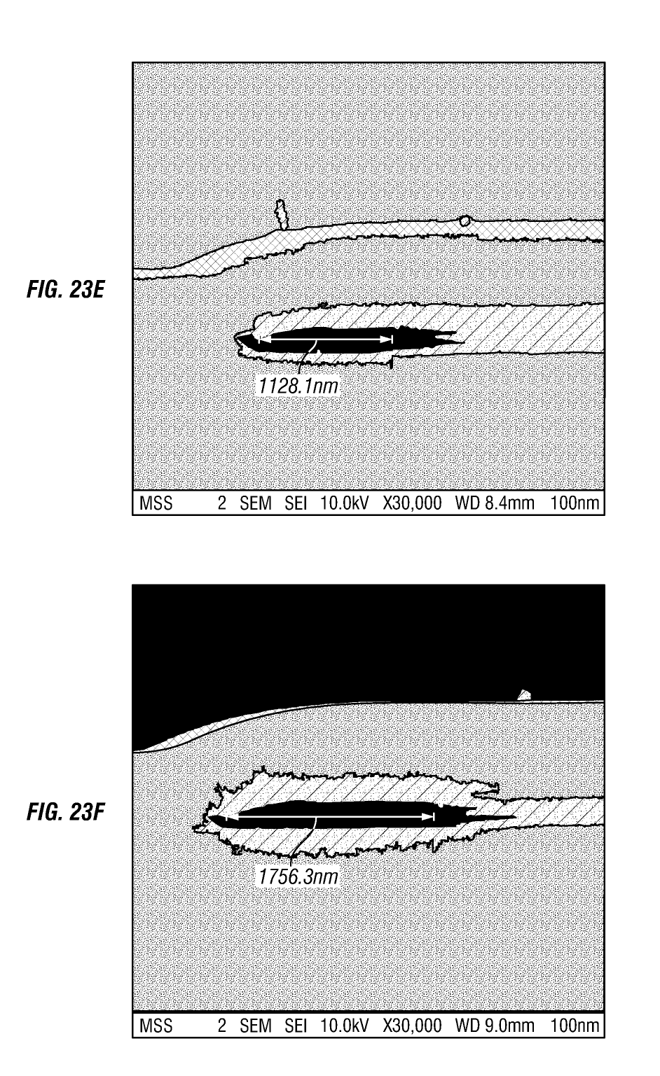

Arrays with one-layer, two-layer, and three-layer sacrificial structures were partially released with two etching cycles. FIGS. 23A-23F are SEM images of cross sections of an interferometric modulator from a corner and the center of each array, as identified in TABLE 2.

TABLE 2

| | 1-Layer | 2-Layer | 3-Layer |
|---|---|---|---|
| Center | FIG. 23A | FIG. 23C | FIG. 23E |
| Corner | FIG. 23B | FIG. 23D | FIG. 23F |

In each image, an etch hole is formed in the left side of the upper layer, and the etching proceeds to the right of the sacrificial structure, which appears as a lighter colored layer in these images. In the etching of the single-layer sacrificial structure illustrated in FIGS. 23A and 23B, the etch front to the right of the etch hole is generally vertical. In contrast, in the multilayer sacrificial structures illustrated in FIGS. 23C-23F, the etch front extends horizontally, apparently along the interface between the sacrificial layers. For the two-layer sacrificial structure illustrated in FIGS. 23C and 23D, the etch front extends along the layer interface, tapering to a point. The etch front of the three-layer sacrificial structure extends along both sacrificial layer interfaces, as illustrated in FIGS. 23E and 23F, tapering to two points.

Those skilled in the art will understand that changes in the apparatus and manufacturing process described above are possible, for example, adding and/or removing components and/or steps, and/or changing their orders. Moreover, the methods, structures, and systems described herein are useful for fabricating other electronic devices, including other types of MEMS devices, for example, other types of optical modulators.

Moreover, while the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. An apparatus comprising a microelectromechanical systems device, wherein the micromechanical systems device comprises:
a sacrificial structure formed over a first structural layer; and
a second structural layer formed over the sacrificial structure, wherein
the second structural layer comprises a plurality of etchant access openings extending through the second structural layer,
the sacrificial structure comprises a first portion proximal to the first structural layer and a second portion distal to the first structural layer,
one of the first portion and the second portion is selectively etchable in the presence the other of the first portion and the second portion, and
the sacrificial structure is selectively etchable in the presence of the first structural layer and the second structural layer.

2. The apparatus of claim 1, wherein one of the first portion of the sacrificial structure and the second portion of the sacrificial structure is etchable by a preselected etchant at a faster rate than the other of the first portion and the second portion.

3. The apparatus of claim 2, wherein the second portion of the sacrificial structure is etchable by the preselected etchant at a faster rate than the first portion of the sacrificial structure.

4. The apparatus of claim 1, wherein the sacrificial structure comprises a sacrificial layer having a graded composition between the first portion of the sacrificial structure and the second portion of the sacrificial structure.

5. The apparatus of claim 1, wherein the first portion of the sacrificial structure comprises a first sacrificial layer and the second portion of the sacrificial structure comprises a second sacrificial layer.

6. The apparatus of claim 5, wherein the first sacrificial layer and the second sacrificial layer have different compressions.

7. The apparatus of claim 5, wherein the sacrificial structure further comprises a third sacrificial layer, wherein at least one of the first sacrificial layer and second sacrificial layer is etchable by a preselected etchant at a faster rate than the third sacrificial layer.

8. The apparatus of claim 1, wherein the first portion of the sacrificial structure comprises a plurality of sacrificial layers forming interface regions therebetween, and the second portion comprises the interface regions.

9. The apparatus of claim 8, wherein the sacrificial layers comprise substantially the same material formed under substantially the same conditions.

10. The apparatus of claim 1, wherein the sacrificial structure comprises at least one of W, Mo, Nb, Ta, Re, Cr, Ni, Al, Ga, In, Sn, Tl, Pb, Bi, Sb, B, Si, Ge, and combinations, alloys, or mixtures thereof.

11. The apparatus of claim 1, wherein the sacrificial structure comprises a photoresist.

12. The apparatus of claim 1, wherein the preselected etchant comprises XeF₂.

13. The apparatus of claim 1, wherein an etching selectivity between the first portion of the sacrificial structure and the second portion of the sacrificial structure is at least about 2.5:1 using the preselected etchant.

14. The apparatus of claim 4, wherein the sacrificial structure consists of two sacrificial layers.

15. The apparatus of claim 1, wherein the first structural layer comprises a dielectric material.

16. The apparatus of claim 15, further comprising an electrode formed below the first structural layer.

17. The apparatus of claim 1, wherein the second structural layer comprises a deformable layer.

18. The apparatus of claim 1, further comprising:
a movable reflective layer formed between the sacrificial structure and the second structural layer;
a connector coupling the second structural layer and the movable reflective layer; and
a layer of a sacrificial material formed between the second structural layer and the movable reflective layer.

19. The apparatus of claim 1, further comprising a support structure extending between the first structural layer and the second structural layer.

20. The apparatus of claim 1, wherein the microelectromechanical systems device is an interferometric modulator.

21. The apparatus of claim 1, further comprising:
a display;
a processor that is configured to communicate with said display, said processor being configured to process image data; and
a memory device that is configured to communicate with said processor.

22. The apparatus of claim 21, further comprising a driver circuit configured to send at least one signal to the display.

23. The apparatus of claim 22, further comprising a controller configured to send at least a portion of the image data to the driver circuit.

24. The apparatus of claim 21, further comprising an image source module configured to send said image data to said processor.

25. The apparatus of claim 24, wherein the image source module comprises at least one of a receiver, transceiver, and transmitter.

26. The apparatus of claim 21, further comprising an input device configured to receive input data and to communicate said input data to said processor.

27. A method of fabricating a microelectromechanical systems device, the method comprising:
forming over a first structural layer a sacrificial structure comprising a first portion proximal to the first structural layer and a second portion distal to the first structural layer, wherein
the sacrificial structure is selectively etchable in the presence of the first structural layer and the second structural layer, and
one of the first portion and the second portion is selectively etchable in the presence of the other of the first portion and the second portion;
forming a second structural layer over the sacrificial structure; and
forming a plurality of etchant access openings extending through the second structural layer.

28. The method of claim 27, wherein one of the first portion and the second portion is etchable by a preselected etchant at a faster rate than the other.

29. The method of claim 28, further comprising etching away one of the first portion and second portion using the preselected etchant.

30. The method of claim 29, wherein etching away one of the first and second portions using the preselected etchant comprises etching away one of the first and second portions using XeF₂.

31. The method of claim 27, wherein forming the sacrificial structure comprises forming a first sacrificial layer proximal to the first structural layer and a second sacrificial layer distal to the first structural layer.

32. The method of claim 27, wherein forming the sacrificial structure comprises forming a sacrificial layer comprising a graded composition between the first portion and the second portion.

33. The method of claim 31, wherein forming the sacrificial structure further comprises forming a third sacrificial layer, wherein a preselected etchant etches at least one of the first sacrificial layer and second sacrificial layer faster than the third sacrificial layer.

34. A method of manufacturing a microelectromechanical systems device comprising:
forming a sacrificial layer over a first layer;
forming a second layer over the sacrificial layer;
selectively etching the sacrificial layer from between the first layer and the second layer to form at least one pillar extending between the first layer and the second layer; and
mechanically decoupling the sacrificial layer from at least one of the first layer and the second layer before etching away the at least one pillar.

35. The method of claim 34, wherein forming the sacrificial layer comprises forming a layer comprising at least one of germanium and molybdenum oxide.

36. The method of claim 35, wherein forming the second layer comprises forming an aluminum movable reflective layer.

37. The method of claim 34, wherein mechanically decoupling the sacrificial layer comprises mechanically decoupling from the second layer.

38. An apparatus comprising a microelectromechanical systems device, wherein the micromechanical systems device comprises:
a first sacrificial layer contacting a first structural layer;
a second sacrificial layer formed over the first sacrificial layer; and
a second structural layer contacting the second sacrificial layer, wherein
the first sacrificial layer and the second sacrificial layer are selectively etchable in the presence of the first structural layer and the second structural layer using a preselected etchant, and
one of the first sacrificial layer and second sacrificial layer is etched by the preselected etchant at faster rate than the other.

39. The apparatus of claim 38, further comprising a plurality of etchant access openings extending through the second structural layer.

40. An apparatus comprising a microelectromechanical systems device, wherein the micromechanical systems device comprises:
a dielectric layer formed over a first conductive layer;
a sacrificial structure formed over the dielectric layer; and
a second conductive layer formed over the sacrificial structure, wherein
the sacrificial structure is selectively etchable in the presence of the dielectric layer and the second conductive layer using a preselected etchant, and
the sacrificial structure comprises a faster etching portion and a slower etching portion with respect to the preselected etchant.

41. The apparatus of claim 40, wherein the sacrificial structure comprises a graded layer of the faster etching portion and the slower etching portion.

42. An apparatus comprising a microelectromechanical systems device, wherein the micromechanical systems device comprises:
a compositionally non-uniform sacrificial structure formed over a first structural layer; and
a second structural layer formed over the sacrificial structure, wherein
the second structural layer comprises a plurality of etchant access openings extending through the second structural layer,
the sacrificial structure is selectively etchable in the presence of the first structural layer and the second structural layer, and
a preselected etchant etches the sacrificial structure non-uniformly.

43. An apparatus comprising a microelectromechanical systems device, wherein the micromechanical systems device comprises:
a first structural means for supporting the microelectromechanical systems device;
a sacrificial means for forming a cavity in the microelectromechanical systems device; and
a second structural means for actuating the microelectromechanical systems device, wherein
the second structural means comprises a plurality of etchant access means for contacting the sacrificial means with an etchant means, and
the sacrificial means comprises a faster etching portion and a slower etching portion.

44. The apparatus of claim 43, wherein the first structural means comprises a substrate.

45. The apparatus of claim 43, wherein the sacrificial means comprises a sacrificial structure.

46. The apparatus of claim 43, wherein the second structural means comprises a deformable layer.

47. A method of manufacturing a microelectromechanical systems device comprising:
forming a sacrificial structure over a first layer;
forming a second layer over the sacrificial structure; and
selectively etching away the sacrificial structure substantially completely from between the first layer and the second layer using a preselected etchant,
wherein the sacrificial structure comprises a faster etching portion and a slower etching portion with respect to the preselected etchant.

48. The method of claim 47, wherein forming a sacrificial structure comprises forming a plurality of sacrificial layers.

49. An apparatus comprising a microelectromechanical systems device, wherein the micromechanical systems device comprises:
a sacrificial structure formed over a first structural layer; and
a second structural layer formed over the sacrificial structure, wherein
the sacrificial structure comprises a first portion and a second portion,
one of the first portion and the second portion has a faster intrinsic etching rate using a preselected etchant,
the sacrificial structure is selectively etchable in the presence of the first structural layer and the second structural layer using the preselected etchant, and
an aspect ratio of a width or length to thickness of the sacrificial structure is at least about 50:1.

50. The apparatus of claim 49, wherein the aspect ratio of the width and length to thickness of the sacrificial structure is at least about 50:1.

51. The apparatus of claim 49, wherein the aspect ratio of the width or length to thickness of the sacrificial structure is at least about 100:1.
